(19) United States
(12) Patent Application Publication
(10) Pub. No.: US 2005/0017127 A1
(43) Pub. Date: Jan. 27, 2005

(54) Mobile object with force generators

(76) Inventor: Vu Xuan Minh, Hanoi (VN)

Correspondence Address: VU XUAN MINH, 24 Ngo 231 Pho Kham Thien, Hanoi, VN

(21) Appl. No.: 10/614,274

(22) Filed: Jul. 8, 2003

(51) Int. Cl. B64C 39/00

(52) U.S. Cl. 244/62

(57) ABSTRACT

A mobile object being a vehicle of any type includes a plurality of force generators, enclosed in a hermetically sealed generator chamber filled with a pressurized gas, and a plurality of engines. Each force generator being a lift device comprises a rotor, which includes a shaft, a rotary shell having an open bottom, and a means supporting the gas in relative equilibrium inside said rotary shell, and a stationary means closing said open bottom of said rotary shell. The specific coordination of the members of said force generator supports the gas on the lower surfaces of the force generator in relative equilibrium and hence produces the maximum difference between the pressures of the gas acting on the lower and upper surfaces of said force generator, i.e. the maximum lift. The force generators, enclosed in said generator chamber, produce the self-action force of said mobile object in accordance with the self-action principle of a solid-fluid body that has been established recently. By controlling the direction of the shafts and angular velocities of the force generators the mobile object can accelerate momentarily in any direction in space. The enclosure of the force generators in the generator chamber makes the self-action force of the mobile object independent of outer environment surrounding it. Any source of energy can be used for self-propulsion of the mobile object due to the direct conversion of the rotational energy into the self-action force without the use of material jets, reactive or external forces.

FIELD OF THE INVENTION

The invention relates to vehicle technology and specifically to flying objects.

### DISCUSSION OF PRIOR ART

All the recent man-made vehicles start and accelerate, speed up or slow down, with the help of either external force, or reaction force, or jet, or their combination. The vehicles are passive in relation to those forces, because the forces are external. Using the external thrusts confines motion possibility of the vehicles, since the vehicles need complex structures and specific conditions for their motion. For example, aircraft needs large wings and expensive airports for lifting and landing; helicopter needs very large blades of its rotor in comparison with its body. Both of them cannot fly at very high altitude because of decreasing of the air density along the altitude of the atmosphere. Spaceship needs an expensive starting complex and cannot accelerate any more after running out of fuel for jet propulsion. Therefore, the maximum speed of the man-made spaceships is very small in comparison with the light speed. On the earth surface ship needs sufficiently deep water to move, submarine cannot dive down too deep because of water pressure, automobile needs motorways, train needs railways, etc. Consequently, the mankind's transport systems are very complicated, expensive, and constrained, and have low safety.

All the man-made vehicles are passive because their motion is based on Newton's laws of motion, in accordance with that the total of internal forces of each vehicle must be zero. However, the laws are stated only for solid bodies or systems of rigid particles and the total internal force may differ from zero for some bodies of other nature. For example, the sum of internal forces of a moving charged particle can differ from zero, although the sum is rather small. So far there has been virtually no exploration of any other body, which can generate a sufficiently large total internal force for practical application in vehicle technology.

### OBJECTS AND ADVANTAGES

Accordingly, the main objects and advantages of my invention are to provide vehicles with mechanisms which allow the vehicles to generate their own total internal force that is their self-action force for starting, accelerating, lifting, landing, and moving in any direction in the air, cosmos, and water (if it is sealed), and on any ground surface and water surface (if the lower part of its body is sealed). The vehicles will make the mankind's transport system much more flexible, simple, cheap, safe, and faster in both the earth's environment and universe.

The above and another objects, advantages and features of my invention will become apparent following examination of drawings and ensuing description herein:

### BRIEF DESCRIPTION OF THE DRAWINGS

FIG. 1 is a schematic isometric view of a mobile object equipped with a force generator with a fragment of the shell of a generator chamber removed to show the arrangement of components of the force generator inside the generator chamber.

FIG. 2 is a side schematic view of the mobile object of FIG. 1 with the shell of the generator chamber removed.

FIG. 3 is a schematic plan view of a disk-stator of the force generator of the mobile object of FIG. 1.

FIG. 4 is a schematic perspective view of a rotor of the force generator of the mobile object of FIG. 1.

FIG. 5 is a diagram of relative position of the solid surfaces inside the mobile object of FIG. 1 with respective labels of the pressure distributions acting on them.

FIG. 6 is a diagram of the pressure distributions over the surfaces of the top disk of the rotor of FIG. 4 and the disk-stator of FIG. 3.

FIG. 7 is a schematic perspective view of a modification of the rotor of FIG. 4.

FIG. 8 is a schematic perspective view of a modification of the disk-stator of FIG. 3.

FIG. 9 is a top plan view of a modification of the mutual pair of the rotor of FIG. 4 and the disk-stator of FIG. 3.

FIG. 10 is a schematic sectional view of the mutual pair of the rotor and the stator of FIG. 9 taken on line 10-10.

FIG. 11 is a schematic perspective view of an alternative mutual pair of rotor and stator.

FIG. 12 is the shape of dividing walls of the mutual pair of rotor and stator of FIG. 11.

FIG. 13 is a schematic perspective view of another mutual pair of rotor and stator.

FIG. 14 is the shape of dividing walls of the mutual pair of rotor and stator of FIG. 13.

FIG. 15 is a schematic side view of a ring-rotor.

FIG. 16 is a schematic top plan view of the ring-rotor of FIG. 15.

FIG. 17 is a schematic sectional view of the ring-rotor of FIG. 15 taken on line 17-17.

FIG. 18 is a schematic top plan view of a ring-stator.

FIG. 19 is a schematic front elevational view of an alternative force generator constructed on the base of a rotor of blades having an airfoil cross-section with a fragment of the shell of its generator chamber removed.

FIG. 20 is a schematic plan view of arrangement of force generators in a conventional aircraft.

FIG. 21 is a schematic side view of an aircraft with its rings removed being equipped with force generators for lifting and propulsion.

FIG. 22 is a schematic plan view of arrangement of the force generators in the aircraft of FIG. 21.

FIG. 23 is a schematic side view of a mobile object having a flying saucer shaped body equipped with force generators.

FIG. 24 is a schematic sectional view of the mobile object of FIG. 23 taken on line 24-24 to show a schematic plan arrangement of its force generators and power devices.

FIG. 25 is an enlarged schematic side view of a turntable supporting force generators.

FIG. 26 is a schematic side view of an alternative mobile object equipped with force generators.

FIG. 27 is a schematic sectional view of the mobile object of FIG. 26 taken on line 27-27 to show a schematic plan arrangement of its force generators and power devices.

REFERENCE NUMERALS OF DRAWINGS

| | | | |
|---|---|---|---|
| 40 | mobile object | 42 | force generator |
| 44 | engine | 46 | gearbox |
| 48 | generator chamber | 50 | structural frame |
| 52 | disk-stator | 54 | rotor |
| 56 | shaft | 58 | fan |
| 60 | fan duct | 62 | generator frame |
| 64 | central circular hole | 66 | hole |
| 68 | circumferential tube | 70 | top disk |
| 72 | open bottom | 74 | central tube |
| 76 | dividing wall | 78 | bearing |
| 80 | bearing | 82 | bearing housing |
| 84 | bearing housing | 86 | supporter |
| 88 | supporter | 90 | nut |
| 92 | washer | 94 | supporter |
| 96 | pulley | 98 | belt |
| 100 | shell | 102 | rotor |
| 104 | stator | 106 | circumferential tube |
| 108 | top disk | 110 | dividing wall |
| 112 | disk | 114 | circumferential tube |
| 116 | rotor | 118 | stator |
| 120 | exterior end | 122 | dividing wall |
| 124 | slit | 126 | circumferential tube |
| 128 | circumferential tube | 130 | rotor |
| 132 | disk-stator | 134 | dividing wall |
| 136 | trapezium | 138 | rotor |
| 140 | stator | 142 | dividing wall |
| 144 | curve | 146 | straight line |
| 148 | ring-rotor | 150 | circumferential tube |
| 152 | central tube | 154 | shaft tube |
| 156 | dividing wall | 158 | top ring |
| 160 | open bottom | 162 | rod |
| 164 | ring-stator | 166 | hole |
| 168 | mobile object | 170 | rotor of blades |
| 172 | generator chamber | 174 | shaft |
| 176 | supporter | 178 | supporter |
| 180 | structural frame | 182 | engine |
| 184 | gearbox | 186 | pump system |
| 188 | mobile object | 190 | aircraft |
| 192 | force generator | 194 | force generator |
| 196 | engine | 197 | mechanical transmission means |
| 198 | engine | 199 | mechanical transmission means |
| 200 | force generator | 202 | force generator |
| 204 | engine | 205 | mechanical transmission means |
| 206 | engine | 207 | mechanical transmission means |
| 208 | mobile object | 210 | aircraft with its rings removed |
| 212 | force generator | 214 | force generator |
| 216 | force generator | 218 | force generator |
| 220 | force generator | 222 | force generator |
| 224 | generator chamber | 226 | floor |
| 228 | engine | 229 | mechanical transmission means |
| 230 | engine | 231 | mechanical transmission means |
| 232 | engine | 233 | mechanical transmission means |
| 234 | engine | 235 | mechanical transmission means |
| 236 | engine | 237 | mechanical transmission means |
| 238 | engine | 239 | mechanical transmission means |
| 240 | rudder | 242 | cockpit |
| 244 | mobile object | 246 | flying saucer shaped body |
| 248 | passenger cabin | 250 | machine cabin |
| 252 | generator chamber | 254 | cockpit |
| 256 | structural frame | 258 | floor |
| 260 | ladder | 262 | door |
| 264 | window | 266 | suspension pier |
| 268 | wheel | 270 | photovoltaic panels |
| 272 | force generator | 274 | force generator |
| 276 | force generator | 278 | force generator |
| 280 | force generator | 282 | force generator |
| 284 | engine | 285 | selectively disengaging means |
| 286 | electrical motor | 287 | selectively disengaging means |
| 288 | mechanical transmission | 290 | engine |
| | means | | |
| 291 | selectively disengaging | 292 | electrical motor |
| | means | | |
| 293 | selectively disengaging | 294 | mechanical transmission means |
| | means | | |
| 296 | engine | 297 | selectively disengaging means |
| 298 | electrical motor | 299 | selectively disengaging means |
| 300 | mechanical transmission | 302 | engine |
| | means | | |
| 303 | selectively disengaging | 304 | electrical motor |
| | means | | |
| 305 | selectively disengaging | 306 | mechanical transmission means |
| | means | | |
| 308 | engine | 309 | selectively disengaging means |
| 310 | electrical motor | 311 | selectively disengaging means |
| 312 | mechanical transmission | 314 | auxiliary power unit |
| | means | | |
| 316 | pump system | 318 | special gateway |
| 320 | turntable | 322 | control motor |
| 324 | turning supporter | 326 | structural supporter |
| 328 | gearwheel | 330 | small gearwheel |
| 332 | hole | 334 | cylindrical shaft |
| 336 | bearing | 338 | bore |
| 340 | shaft | 342 | clutch |
| 343 | shaft | 344 | control unit |
| 345 | fuel tank | 346 | mobile object |
| 348 | body of aerodynamic | 350 | pilot cabin |
| | shape | | |
| 352 | machine cabin | 354 | rudder |
| 356 | structural frame | 358 | floor |
| 360 | lower section of a floor | 362 | glass screen |
| 364 | door | 366 | suspension pier |
| 368 | wheel | 370 | force generator |
| 372 | force generator | 374 | engine |
| 376 | mechanical transmission | 378 | engine |
| | means | | |
| 380 | mechanical transmission | 382 | rectangular frame |
| | means | | |
| 384 | shaft | 386 | strut |
| 388 | strut | 390 | hydraulic jack |
| 392 | hydraulic jack | 398 | engine |
| 400 | mechanical transmission | 402 | control unit |
| | means | | |
| 404 | fuel tank | | |

### SUMMARY OF THE PRINCIPLES OF THE INVENTION

In the present invention mobile objects including all types of vehicles are constructed on the base of the self-action principle of a solid-fluid body that has been discovered recently. Each of the mobile objects is presented as a solid-fluid body, which is a hermetically sealed solid chamber filled up with a fluid and containing a set of internal solid elements. The self-action principle states that a solid-fluid body except external forces is acted upon by a self-action force that equals to the sum of the time rate of change of the momentum of the whole fluid as a lump in free space and the total force due to the pressure and shear stress distributions of the fluid over the surfaces of its solid elements reduced by the force due to its body force. Therefore, in the case of absence of external forces each of the mobile objects can accelerate itself by using its self-action force. Since the self-action force is the total of internal forces of a solid-fluid body, the mobile object constructed on the base of the self-action principle can accelerate itself in any environment (in the atmosphere, water, cosmos, etc.) without the use of jets, reactive or external forces. The other advantage of the mobile object is that its self-action force can be increases as many times as desirable due to increasing the pressure of the fluid that is usually a pressurized air or gas.

In order to produce large self-action forces for the mobile objects force generators, which are aerodynamic lift devices mounted inside the hermetically sealed solid chamber of each mobile object, are invented on the base of the technique of support of the gas on its lower surfaces in relative equilibrium. Each force generator comprises a rotary shell having an open bottom, the means supporting the gas in relative equilibrium inside said rotary shell, and the stationary means closing the open bottom of said rotary shell. The rotary shell and the means supporting the gas in relative equilibrium inside the shell constitute the rotor of the force generator. The special arrangement and strict coordination of said rotor and said stationary means supports the gas on the lower surfaces of the force generator, i.e. the rotary shell together with the stationary means, in relative equilibrium, while the relative velocity of the gas on its upper surfaces is proportional to the angular velocity of the shaft of its rotor. As a result, the force generator produces the maximum difference between the pressures of the gas acting on its lower and upper surfaces, i.e. the maximum lift.

### DETAILED DESCRIPTION OF THE INVENTION

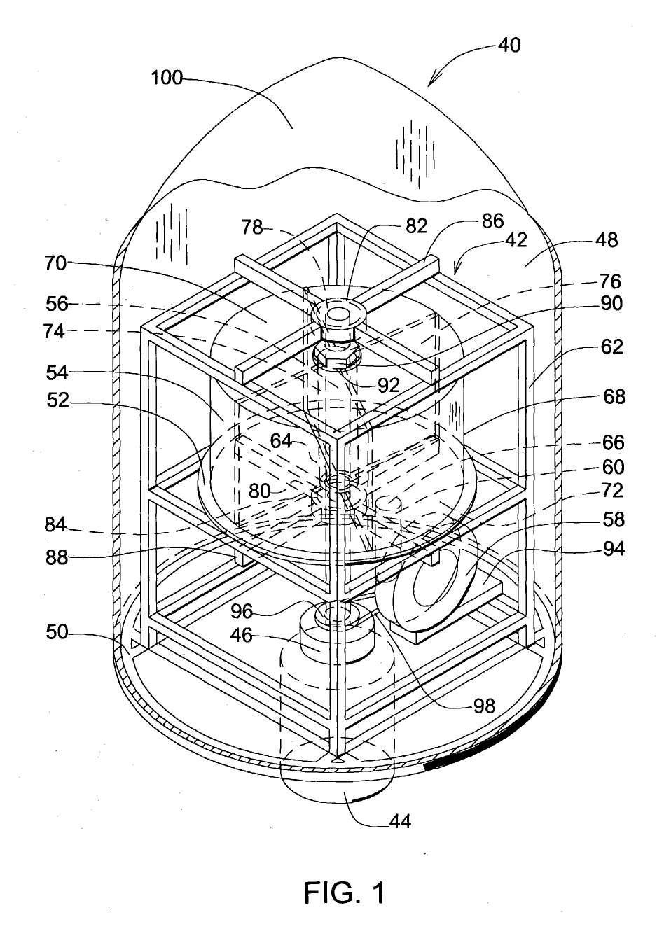

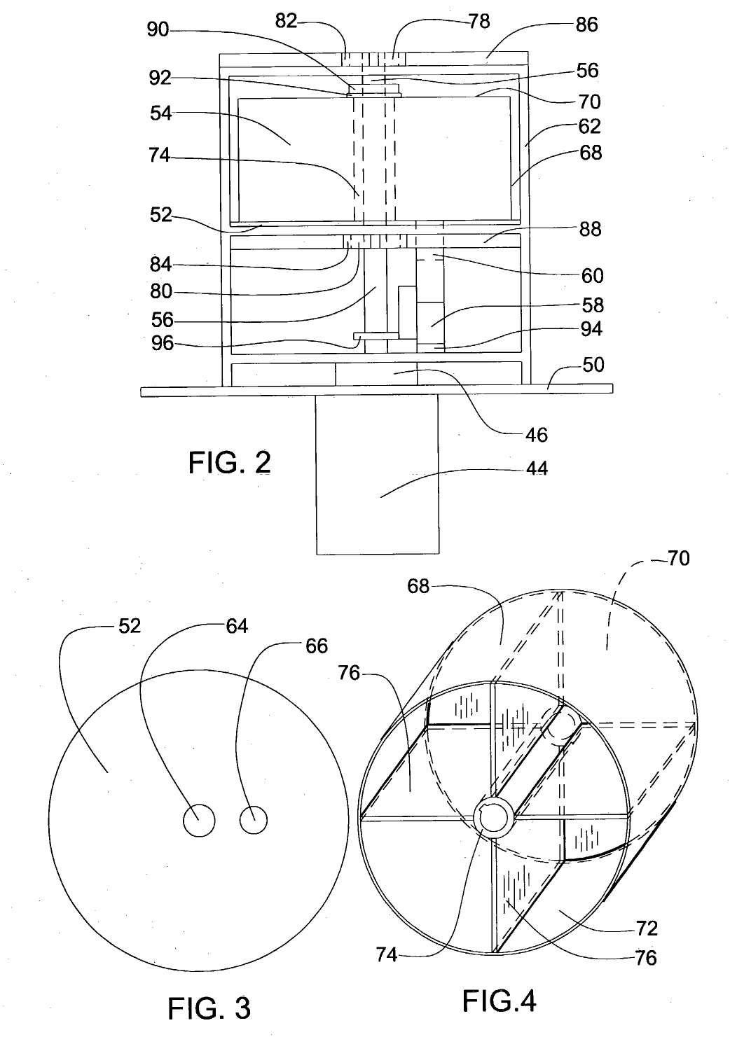

Referring now to the drawings, a mobile object constructed in accordance with one embodiment of the present invention is indicated generally at 40 in FIG. 1. Mobile object 40 includes a force generator indicated generally at 42, an engine 44, a gearbox 46, a generator chamber 48, and a structural frame 50. Force generator 42 comprises (see also FIG. 2) a disk-stator 52, a rotor 54, a shaft 56 of the rotor, a fan 58, a fan duct 60, and a generator frame 62. Disk-stator 52 (see also FIG. 3) is a disk having a central circular hole 64 as a free space for assembly of the disk-stator and the shaft, and a hole 66 being the outlet of fan duct 60. Rotor 54 comprises (see also FIG. 4) a circumferential tube 68 having its upper end closed by a top disk 70, an open bottom 72, a central tube 74 for the shaft assembly, and dividing walls 76. Dividing walls 76 extend from central tube 74 to circumferential tube 68 and from top disk 70 to open bottom 72 so that dividing walls 76 together with central tube 74 divide the inner space of rotor 54 into separate sections. Shaft 56 is supported by bearings 78 and 80 arranged in bearing housings 82 and 84 respectively. The bearing housings 82 and 84 are secured to supporters 86 and 88 respectively. Disk-stator 52 and supporters 86 and 88 are secured to generator frame 62 of the force generator by screws or other suitable fasteners. Rotor 54 is mounted on shaft 56 and is secured by a nut 90 with a washer 92 on its top. Fan 58 is mounted to a supporter 94 being secured to generator frame 62 (or to structural frame 50). Shaft 56 has a pulley 96 (or a gear) which together with a belt 98 (or a gear train) and a pulley (not shown) on the shaft (or a gear on the shaft) of fan 58 serves as a mechanical transmission means from shaft 56 of rotor 54 to the shaft of fan 58. Generator frame 62 of the force generator is secured to structural frame 50 of mobile object 40 by welds or other suitable fasteners. The structure of shaft 56 provides such a position of rotor 54 that after the assembly of force generator 42 the clearance between the upper surface of disk-stator 52 and the plane of open bottom 72 of rotor 54 is as small as possible. Gearbox 46 is a mechanical transmission means from engine 44 to shaft 56. Generator chamber 48 has a shell 100 being secured to structural frame 50 by a suitable means. Generator chamber 48 is filled with a working gas, which may be the air or any other gas. Engine 44 may be of turbo-prop, prop-fan, piston engine, or other types. The engine may be also an electrical motor, particularly when the solar energy is used. Engine 44 and gearbox 46 are secured to structural frame 50 by suitable means (not shown). Engine 44 in FIG. 1 is located outside shell 100 of generator chamber 48. Engine 44 may be also situated inside generator chamber 48. In that case the inlet and outlet passages of air flows and exhausted gases necessary for operation of the engine should be isolated from the working gas in generator chamber 48. Rotor 54 can be made of aluminum alloy, steel, composite materials, or other suitable rigid materials. It is desirable to make the rotor as light as possible for the sake of saving energy. Disk-stator 52 can be made of aluminum alloy, steel, composite materials, or other rigid materials. Shell 100 can be made of steel or any other rigid materials, provided the shell can suffer the pressure of the working gas. In some applications generator chamber 48 may be pressurized. In that case generator chamber 48 is hermetically sealed and a means (not shown) for pressurizing the generator chamber may be powered from engine 44.

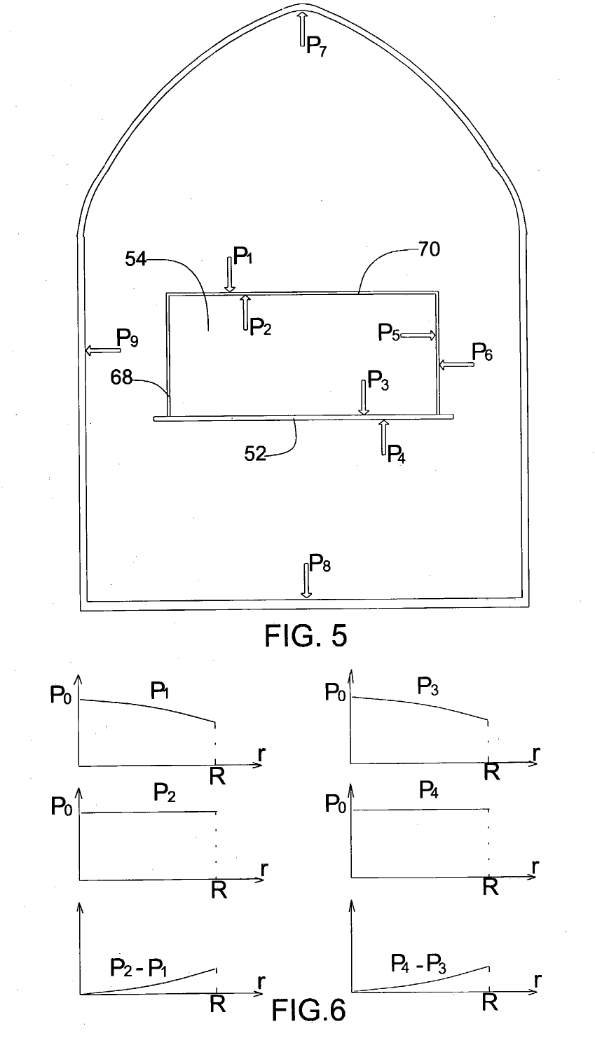

In operation, rotor 54 and fan 58 are driven from engine 44 through gearbox 46. During rotation of rotor 54 the working gas in the space bounded by disk-stator 52 and rotor 54 rotates together with the rotor and sweeps over the upper surface of disk-stator 52 due to dividing walls 76 which skim the upper surface of disk-stator 52 to accompany the working gas. Whereby the working gas is supported in relative equilibrium inside rotor 54. Because of the centrifugal force some part of the working gas in the space bounded by disk-stator 52 and rotor 54 is exhausted through the clearance between the upper surface of disk-stator 52 and the circumference of open bottom 72 or the bottom edge of circumferential tube 68 of rotor 54. The exhausted gas is continuously compensated by the gas flows entering into the space bounded by disk-stator 52 and rotor 54 through fan duct 60 due to the operation of fan 58. The rotation of rotor 54 creates different relative gas flows over the surfaces of disk-stator 52 and rotor 54. The different relative gas flows, in turn, exert different pressures on the surfaces. As a result, the difference in pressure distribution over the lower and upper surfaces of disk-stator 52 and the difference in pressure distribution over the lower and upper surfaces of top disk 70 of rotor 54 exert forces on disk-stator 52 and rotor 54 respectively. The sum of the forces acts on mobile object 40 through the shaft, mechanical joints, fasteners, supporters, and structural frame of the mobile object in the upward direction along shaft 56 (from the lower surface to upper surface of the disk-stator or the top disk of the rotor). The sum of the forces generated by force generator 42 is the self-action force of mobile object 40, since it is the internal force of the mobile object. The detailed discovery of the self-action force of mobile object 40 generated by its force generator 42 is explained by considering the pressure distributions of the gas flows over the solid surfaces inside mobile object 40. FIG. 5 is a diagram of relative position of the solid surfaces inside mobile object 40. The letter P with a subscript denotes the pressure distribution over each solid surface. P₁ and P₂ are the pressure distributions over the upper and lower surfaces of top disk 70 of rotor 54 respectively. P₃ and P₄ are the pressure distributions over the upper and lower surfaces of disk-stator 52 respectively. P₅ and P₆ are the pressure distributions over the inside and outside surfaces of circumferential tube 68 respectively. P₇, P₈, and P₉ are the pressure distributions over the surfaces of the ceiling, floor, and wall of generator chamber 48 respectively. Finally, we denote the static pressure in generator chamber 48 by P₀, that is the pressure in the state when force generator 42 is at rest. It is obvious that P₇ and P₈ are almost equal to P₀ and the resultant aerodynamic forces acting on mobile object 40 from the pressure distributions P₇ and P₈ cancel each other. The resultant aerodynamic force acting on mobile object 40 from the pressure distribution P₉ vanishes because of the symmetry of the pressure distribution. The resultant aerodynamic forces acting on the inside and outside surfaces of circumferential tube 68 of rotor 54 from the pressure distributions P₅ and P₆ respectively are equal to zero due to the geometric symmetry of the circumferential tube relative to the rotational axis of rotor 54. Therefore, the resultant aerodynamic forces acting on mobile object 40 from the pressure distributions P₁, P₂, P₃, and P₄ remain to be considered. FIG. 6 is a diagram of the pressure distributions over the upper and lower surfaces of top disk 70 (P₁ and P₂) and disk-stator 52 (P₃ and P₄). At a given angular velocity of rotor 54 the velocity at each point of the surface of top disk 70 is the angular velocity times the radius of the circle of the point's trajectory. The point's velocity is also the relative velocity of the gas flow above the circle with respect to the upper surface of top disk 70. Therefore, the pressure distribution P₁ over the upper surface of top disk 70 reduces with increasing of the radius denoted by r in FIG. 6. In the figure R is the radius of circumferential tube 68. The gas in the space bounded by stator 52 and rotor 54 rotates together with the rotor due to dividing walls 76 and, therefore, is supported in relative equilibrium. Consequently, the relative velocity of the gas flow inside rotor 54 with respect to the lower surface of top disk 70 is almost equal to (or a little greater than) zero. Therefore, the pressure distribution P₂ over the lower surface of top disk 70 is almost constant and approximately equal to the static pressure P₀. Then the difference in pressure distribution, P₂−P₁, between the lower and upper surfaces of top disk 70 rises along the radius r. The difference in pressure, when multiplied by the area over which it acts, produces the force acting on top disk 70 or rotor 54 in the direction along the axis of the rotor from the lower surface to the upper surface of top disk 70. The difference in pressure (P₂−P₁) gets its maximum value for every angular velocity of rotor 54, since P₂ is the pressure of the gas in relative equilibrium. While the gas in the space bounded by disk-stator 52 and rotor 54 rotates together with the rotor due to dividing walls 76, disk-stator 52 is fixed. Therefore, the gas inside rotor 54 sweeps over the upper surface of disk-stator 52. Then the relative velocity of the gas flow over the upper surface of disk-stator 52 increases with increasing of the radius r. Consequently, the pressure distribution P₃ over the upper surface of disk-stator 52 reduces with increasing of the radius r. Finally, the pressure distribution P₄ over the lower surface of disk-stator 52 is almost constant and approximately equal to the static pressure P₀, because the disk-stator is fixed, the volume of the exhausted gas per unit time may be made very small in comparison with the whole gas volume in generator chamber 48, and the relative velocity of the gas flow over its lower surface is almost zero or in relative equilibrium. Then the difference in pressure distribution, P₄−P₃, between the lower and upper surfaces of disk-stator 52 rises along the radius r. The difference in pressure, when multiplied by the area over which it acts, produces the force acting on disk-stator 52 in the direction along the axis of rotor 54 from the lower surface to the upper surface of disk-stator 52. The difference in pressure (P₄−P₃) gets its maximum value for every angular velocity of rotor 54, since P₄ is the pressure of the gas in relative equilibrium. The sum of the resultant aerodynamic forces created by the differences in pressure distribution, (P₂−P₁) and (P₄−P₃), is the force generated by force generator 42 in the direction along the axis of rotor 54 from the lower surface to the upper surface of disk-stator 52 or top disk 70. The force is the thrust force generator 42 acts on the whole body of mobile object 40 through its shaft, mechanical joints, fasteners, supporters, and the structural frame of the mobile object in the upward direction along the axis of shaft 56. The force generated by force generator 42 is the internal force of mobile object 40, since it is defined only by interaction between the surfaces of the solid structure and the flows of the working gas inside the mobile object, that is the generated force is the self-action force of mobile object 40 and does not depend on the outer environment surrounding the mobile object.

Those skilled in the art know that in accordance with Newton's laws of motion the total of internal forces of a solid body or a system of solid particles vanishes. In other words, the discovery of the self-action force of mobile object 40 cannot be explained in the scope of Newton's mechanics. Therefore, for the sake of the precise and well-grounded discovery of the self-action force of mobile object 40 a new mechanics must be founded. For assertion of the discovery of the self-action force of mobile object 40 the fundamentals of the mechanics of solid-fluid bodies have been established and applied to the analysis of mobile object 40. In the new mechanics mobile object 40 is considered as a whole mechanical system, which is called a solid-fluid body. The elaboration of the establishment is presented below.

Under a solid-fluid body we mean a hermetically sealed solid chamber filled up with a fluid and containing a set of internal solid elements. Suppose the solid-fluid body comprises N solid elements, among which its solid chamber is labeled as Ith solid element and its internal solid elements are labeled as 2nd to Nth solid elements. Then the momentum equation for the ith solid element can be written as

$$\frac{ⅆ}{ⅆ t} {\vec{p}}_{i} = \frac{ⅆ}{ⅆ t} {m}_{i} {\vec{v}}_{i} = {\sum }_{j}^{} {\vec{F}}_{ij} + {\vec{F}}_{i}^{( p )} + {\vec{F}}_{i}^{( τ )} + {\vec{F}}_{i}^{( c )} , i , j = 1 , 2 , … , N \qquad ( 501 )$$

In Eq. (501) \vec{F}ᵢⱼ stands for the force on the ith solid element due to the jth solid element; \vec{F}ᵢ^{(p)} and \vec{F}ᵢ^{(τ)} are the forces on the ith solid element due to the pressure and shear stress distributions of the fluid respectively over the surface of the ith solid element; and \vec{F}ᵢ^{(e)} is the total external force acting on the ith solid element.

Further, the momentum equation for the total fluid can be written in the integral form as follows

$$\frac{\partial }{\partial t} {∯ \int }_{v ( t )} ρ ( \vec{v} + \vec{V} ) ⅆ v + {∮ \int }_{S ( t )} ( ρ \vec{V} … ⅆ \vec{S} ) \vec{V} = - {∮ \int }_{S ( t )} p ⅆ \vec{S} - {∮ \int }_{S ( t )} \vec{τ} ⅆ S + {∯ \int }_{v ( t )} ρ \vec{f} ⅆ v \qquad ( 502 )$$

where ν(t) and S(t) are the volume and boundary surface of the fluid respectively. They are time functions due to motion of the internal solid elements. The first term in the left side is the time rate of change of the momentum of the fluid due to motion of the fluid with the velocity \vec{ν}₀=\vec{ν}+\vec{V}, in which \vec{ν} is the velocity of the whole solid-fluid body or the velocity of the solid chamber, \vec{ν}=\vec{ν}₁, and \vec{V} is the velocity of the fluid particles relative to the solid chamber. The second term in the left side is the flow of momentum out of the space containing the fluid. The first term in the right side of the equation is the complete pressure force over the entire surface of the fluid. The second term in the right side is the shearing force, i.e. complete reaction of all the solid elements against the shear stress distribution of the fluid over them. The third term is the total body force exerted on the fluid.

The first term in the left side can be written as

$$\frac{\partial }{\partial t} {∯ \int }_{v ( t )} ρ ( \vec{v} + \vec{V} ) ⅆ v = \frac{ⅆ}{ⅆ t} {\vec{p}}_{0} + \frac{\partial }{\partial t} {∯ \int }_{v ( t )} ρ \vec{V} ⅆ v \qquad ( 503 )$$

where the first term in the right side of Eq. (503) is the time rate of change of the momentum of the whole fluid as a lump in free space.

The surface of the fluid is confined to the surfaces of the solid elements. Therefore, the second term in the left side of Eq. (502) vanishes

$${∮ \int }_{S ( t )} ( ρ \vec{V} . ⅆ \vec{S} ) \vec{V} ) = 0 \qquad ( 504 )$$

Then summing the momentum Eq. (501) for all the solid elements with Eq. (502) for the fluid gives

$${\sum }_{i = 0}^{N} \frac{ⅆ}{ⅆ t} {\vec{p}}_{i} {\frac{\partial }{\partial t} ∯ \int }_{v ( t )} ρ \vec{V} ⅆ v = {{\sum }_{i , j = 1}^{N}}_{i \neq j} {\vec{F}}_{ij} + {\sum }_{i = 1}^{N} {\vec{F}}_{i}^{( p )} + {\sum }_{i = 1}^{N} {\vec{F}}_{i}^{( τ )} - {∮ \int }_{S ( t )} p ⅆ \vec{S} - {∮ \int }_{S ( t )} \vec{τ} ⅆ S + {∯ \int }_{S ( t )} ρ \vec{f} ⅆ v + {\sum }_{i = 1}^{N} {\vec{F}}_{i}^{( e )} \qquad ( 505 )$$

Applying Newton's third law for interaction between the solid elements and their interaction with the fluid yields

$$\begin{matrix}{{\sum }_{i , j = 1}^{N}}_{i \neq j} {\vec{F}}_{ij} = 0 & ( 506 ) \\ {\sum }_{i = 1}^{N} {\vec{F}}_{i}^{( p )} - {∮ \int }_{S ( t )} p ⅆ \vec{S} = 0 and & ( 507 ) \\ {\sum }_{i = 1}^{N} {\vec{F}}_{i}^{( τ )} - {∮ \int }_{S ( t )} p ⅆ \vec{S} = 0 & ( 508 )\end{matrix}$$

Thus the momentum equation of the solid-fluid body must be written

$${\sum }_{i = 0}^{N} \frac{ⅆ}{ⅆ t} {\vec{p}}_{i} = - \frac{\partial }{\partial t} {∯ \int }_{v ( t )} ρ \vec{V} ⅆ v + {∯ \int }_{v ( t )} ρ \vec{f} ⅆ v + {\sum }_{i = 1}^{N} {\vec{F}}_{i}^{( e )} \qquad ( 509 )$$

In Eq. (509) the term in the left side, which is the time rate of change of the total of the momentums of all the elements of the solid-fluid body in free space, must be equal to the total force acting on the solid-fluid body to accelerate it in free space; the second and third terms in the right side represent the total of external forces acting on the solid-fluid body. Therefore, the first term in the right side must be a force that the solid-fluid body acts on itself due to unsteady flow fluctuations of the fluid. We denote this force by \vec{F}ₛ, i.e.

$${\vec{F}}_{s} = - \frac{\partial }{\partial t} {∯ \int }_{v ( t )} ρ \vec{V} ⅆ v \qquad ( 510 )$$

Substituting Eq. (501) for the time rate of change of the momentum of each solid element in Eq. (509) gives

$${\sum }_{i = 1}^{N} ( {\vec{F}}_{i}^{( p )} + {\vec{F}}_{i}^{( τ )} ) + {\sum }_{i = 1}^{N} {\vec{F}}_{i}^{( e )} + \frac{ⅆ}{ⅆ t} {\vec{p}}_{0} = - \frac{\partial }{\partial t} {∯ \int }_{v ( t )} ρ \vec{V} ⅆ v + {∯ \int }_{v ( t )} ρ \vec{f} ⅆ v + {\sum }_{i = 1}^{N} {\vec{F}}_{i}^{( e )} \qquad ( 511 )$$

From Eqs. (510) and (511) we obtain

$${\vec{F}}_{s} = - \frac{\partial }{\partial t} {∯ \int }_{v ( t )} ρ \vec{V} ⅆ v = {\sum }_{i = 1}^{N} ( {\vec{F}}_{i}^{( p )} + {\vec{F}}_{i}^{( τ )} ) + \frac{ⅆ}{ⅆ t} {\vec{p}}_{0} - {∯ \int }_{v ( t )} ρ \vec{f} ⅆ v \qquad ( 512 )$$

Then Eqs. (509) and (512) allow us to formulate the following

SELF_ACTION PRINCIPLE: A solid-fluid body except external forces is acted upon by a self-action force, \vec{F}ₛ, equal to the sum of the time rate of change of the momentum of the whole fluid as a lump in free space and the total force due to the pressure and shear stress distributions of the fluid over the surfaces of its solid elements reduced by the force due to its body force, i.e.

$${\vec{F}}_{s} = \frac{ⅆ}{ⅆ t} {\vec{p}}_{0} + {\sum }_{i = 1}^{N} ( {\vec{F}}_{i}^{( p )} + {\vec{F}}_{i}^{( τ )} ) - {∯ \int }_{v ( t )} ρ \vec{f} ⅆ v \qquad ( 513 )$$

We see that the self-action principle is equivalent to the momentum Eq. (509). Let us denote the relative velocity of ith solid element inside the solid-fluid body by \vec{V}ᵢ, that is \vec{V}ᵢ=\vec{ν}ᵢ−\vec{ν} and call the value mᵢ\vec{V}ᵢ its relative internal momentum. Then the momentum Eq. (509) can be written as

$$( {\sum }_{i = 0}^{N} {m}_{i} ) \vec{a} + {\sum }_{i = 1}^{N} {m}_{i} \frac{ⅆ}{ⅆ t} {\vec{V}}_{i} = - \frac{\partial }{\partial t} {∯ \int }_{v ( t )} ρ \vec{V} ⅆ v + {∯ \int }_{v ( t )} ρ \vec{f} ⅆ v + {\sum }_{i = 1}^{N} {\vec{F}}_{i}^{( e )} \qquad ( 514 )$$

From Eqs. (512) and (514) we obtain the momentum equation of the solid-fluid body in the form

$$M \vec{a} = {\sum }_{i = 1}^{N} ( {\vec{F}}_{i}^{( p )} + {\vec{F}}_{i}^{( τ )} ) + {\sum }_{i = 1}^{N} {\vec{F}}_{i}^{( e )} - {\sum }_{i = 0}^{N} {m}_{i} \frac{ⅆ}{ⅆ t} {\vec{V}}_{i} \qquad ( 515 )$$

where

$$M = {\sum }_{i = 1}^{N} {m}_{i}$$

is the total mass of all the solid elements of the solid-fluid body.

In order to assert the existence of the self-action force it is sufficient to consider a simple example described below.

Suppose a solid-fluid body is a hermetically sealed cylindrical solid chamber filled up with a fluid. Its cross-section area and length are A and l respectively. The cylindrical chamber contains no internal solid element. The external force, \vec{F}₁^{(e)}, acting upon the chamber and the body force, \vec{f}, of the fluid are constant and have the same direction along its generatrix that lies on x-axis. The body force is uniform and the fluid is incompressible.

It is obvious that the shear stress is absent, \vec{F}₁^{(τ)}=0. The pressure along x-axis, i.e. the generatrix of the cylindrical chamber, can be found from the equation of fluid in relative equilibrium, that is

$$\frac{ⅆ p}{ⅆ t} = - ρ a \qquad ( 516 )$$

where ρ is the density of the fluid and a is the component of the acceleration of the cylindrical chamber in the direction of x-axis. Integrating the equation along the generatrix from 0 to l gives
pₗ−p₀=−lρa (517)
where p₀ and pₗ are the pressures of the fluid at the two ends of the cylindrical chamber.

Then the total force in the direction of x-axis due to the pressure distribution over the surfaces of the cylindrical chamber is
\vec{F}₁^{(p)}=îA(pₗ−p₀)=−Alρ\vec{a}=−m₀\vec{a} (518)
where î is the unit vector of x-axis.

Putting the total force \vec{F}₁^{(p)} due to the pressure distribution over the surfaces of the cylindrical chamber and the body force \vec{f} of the fluid into Eq. (513) gives the self-action force of the cylindrical chamber in the direction of x-axis

$${\vec{F}}_{s} = \frac{ⅆ}{ⅆ t} {\vec{p}}_{0} - {m}_{0} \vec{a} - Al ρ \vec{f} = - {m}_{0} \vec{f} \qquad ( 519 )$$

Eq. (519) shows that the self-action force of the cylindrical chamber always exists except the case of absence of the fluid or its body force. By analogy, it is easy to find the self-action force of solid-fluid bodies containing no internal solid element and having other shapes of their solid chambers. The above class of solid-fluid bodies is the class of simplest ones, since they contain no internal solid element. For solid-fluid bodies containing internal solid elements their self-action force can be increased very strongly due to interaction between their internal solid elements and fluid. The examples of solid-fluid bodies containing internal solid elements are the mobile objects presented in this invention. The application of the self-action principle to analysis of their dynamics will be considered after establishment of the relationship of the self-action principle with Newton's laws of motion and the conservation law for momentum based on Newton's laws.

It is obvious that the existence of the self-action force has disproved Newton's second law for solid-fluid bodies, since the law ignores their self-action force. For illustration of the breakdown of Newton's second law we consider again the solid-fluid body of the above example, i.e. the cylindrical chamber. We now define the acceleration of the cylindrical chamber by using the momentum Eq. (515). The last term in the right side of Eq. (515) equals to zero, since the cylindrical chamber contains no internal solid element. Then putting the total force due to the pressure distribution of the fluid over the surfaces of the cylindrical chamber and the external force acting upon the chamber into Eq. (515) yields
m₁\vec{a}=−m₀\vec{a}+\vec{F}₁^{(e)} (520)
Hence we obtain

$$\vec{a} = \frac{{\vec{F}}_{1}^{( e )}}{{m}_{0} + {m}_{1}} \qquad ( 521 )$$

Formula (521) shows the true acceleration of the cylindrical chamber.

If the self-action force of the cylindrical chamber was ignored and its acceleration was defined by Newton's second law, its Newtonian acceleration, \vec{a}_{N}, would be

$${\vec{a}}_{N} = \frac{{m}_{0} \vec{f} + {\vec{F}}_{1}^{( e )}}{{m}_{0} + {m}_{1}} \qquad ( 522 )$$

Comparing the true acceleration \vec{a} of the cylindrical chamber with its Newtonian acceleration \vec{a}_{N} we see that, in general, the Newtonian acceleration differs from the true acceleration except the case of absence of the fluid or its body force.

The breakdown of Newton's second law implies the breakdown of Newton's first law for solid-fluid bodies, since the first law is a consequence of the second one.

The breakdown of Newton's second law implies also the breakdown of Newton's third law for solid-fluid bodies, since under the action of an interactive force, \vec{F}^{±}, between two solid-fluid bodies their resultant forces, \vec{F}¹ and \vec{F}², differ from each other due to the difference between their self-action forces, which depend on their structure, that is \vec{F}₁=\vec{F}+\vec{F}₁ₛ and \vec{F}₂=−\vec{F}+\vec{F}₂ₛ imply \vec{F}₁≠−\vec{F}₂ if \vec{F}₁ₛ≠−\vec{F}₂ₛ. For illustration of the breakdown of Newton's third law we consider the interaction between two solid-fluid bodies, each of which is the cylindrical chamber described in the above example. We denote the masses of the fluid and cylindrical chamber of the first solid-fluid body by m₁₀ and m₁₁ respectively, and the second solid-fluid body by m₂₀ and m₂₁, respectively. Then their body forces are

$$\begin{matrix}{\vec{f}}_{1} = \frac{\vec{F}}{{m}_{10} + {m}_{11}} \\ and & ( 523 ) \\ {\vec{f}}_{2} = \frac{\vec{F}}{{m}_{20} + {m}_{21}} & ( 524 )\end{matrix}$$

Using formulae (519), (523), and (524) we obtain the self-action forces of the solid-fluid bodies

$$\begin{matrix}{\vec{F}}_{1 s} = \frac{{m}_{10} \vec{F}}{{m}_{10} + {m}_{11}} \\ and & ( 525 ) \\ {\vec{F}}_{2 s} = \frac{{m}_{20} \vec{F}}{{m}_{20} + {m}_{21}} & ( 526 )\end{matrix}$$

Formulae (525) and (526) show that in general \vec{F}₁ₛ≠−\vec{F}₂ₛ except the special case when

$$\frac{{m}_{10}}{{m}_{10} + {m}_{11}} = \frac{{m}_{20}}{{m}_{20} + {m}_{21}} \qquad ( 527 )$$

Thus we have seen that all Newton's laws of motion have been broken down for solid-fluid bodies, although the laws were applied to description of the dynamics of their solid elements and fluid particles in the conclusion of the momentum equation and self-action principle of a solid-fluid body. In other words, Newton's laws of motion are satisfied for individual solid elements and fluid particles of a solid-fluid body, but they are broken down in the whole solid-fluid body due to solid-fluid interaction. Therefore, it is necessary to correct Newton's laws of motion for the sake of unifying the fundamentals of mechanics.

When a solid-fluid body moves in free space, only its external momentum can be watched from the outer, whereas its internal can be not. Therefore, we must differ them from each other. Its external momentum is the value

$${{p}^{->}}_{ext} = ( {\sum }_{i = 0}^{N} {m}_{i} ) {v}^{->} = ( M + {m}_{0} ) {v}^{->} \qquad ( 528 )$$

Since \vec{V}ᵢ and \vec{V} are relative velocities of the internal solid elements and fluid particles inside the solid chamber respectively, the internal momentum of the solid-fluid body can be defined as the value

$${{p}^{->}}_{int} = {\sum }_{i = 2}^{N} {m}_{i} {{V}^{->}}_{i} + {∯ \int }_{v ( t )} ρ {V}^{->} ⅆ v \qquad ( 529 )$$

Then the momentum Eq. (514) can be written as

$$\frac{ⅆ}{ⅆ t} ( {{p}^{->}}_{ext} + {{p}^{->}}_{int} ) = {∯ \int }_{v ( t )} ρ {f}^{->} ⅆ v + {\sum }_{i = 1}^{N} {{F}^{->}}_{i}^{( e )} \qquad ( 530 )$$

The momentum Eq. (530) differs from Newton's second law only in the presence of the internal momentum \vec{p}ᵢₙₜ. Therefore, Eq. (530) allows us to formulate the following

GENERALIZED NEWTON'S SECOND LAW: The time rate of change of the total of external and internal momentums of a solid-fluid body is directly proportional to the total of external forces acting on it and takes place in the direction of the total force.

We see that the self-action principle and generalized Newton's second law are equivalent, since both of them are equivalent to the momentum equation of the solid-fluid body.

If the external momentum \vec{p}ₑₓₜ is constant, then from Eq. (530) we have

$$\frac{ⅆ}{ⅆ t} {{p}^{->}}_{int} = ∯ \int ρ {f}^{->} ⅆ v + {\sum }_{i = 1}^{N} {{F}^{->}}_{i}^{( e )} \qquad ( 531 )$$

Eq. (531) allows us to formulate the following

GENERALIZED NEWTON'S FIRST LAW: Every solid-fluid body continues in its state of rest or uniform motion in a straight line if the total of external forces acting on it equals to the time rate of change of its internal momentum.

We notice that the sense of the interactive force in Newton's third law remains correct for solid-fluid bodies only if Eq. (530) or the generalized Newton's second law is applied to their dynamics. Therefore, we can formulate the following

GENERALIZED NEWTON'S THIRD LAW: Whenever one solid-fluid body exerts a certain force on a second solid-fluid body, the second body exerts an equal and opposite force on the first and the time rate of change of the total of external and internal momentums of either body obeys the generalized Newton's second law.

We see that the above generalized Newton's laws of motion are consequences of the self-action principle or momentum equation of a solid-fluid body. We notice that the original Newton's laws of motion are special cases of the generalized ones when the fluid is absent in bodies or their total internal momentum is constant. Now the reason of the breakdown of the original Newton's laws of motion for solid-fluid bodies is clear. Isaac Newton in his famous Principia, published in 1687, stated the laws of motion only for (absolutely) solid bodies. The condition of the (absolutely) solid state of the bodies allowed Newton to consider them as material points and ignore their internal momentums. From the Newton's times up to now his laws have been applied to any body with the neglect of its internal momentums. The self-action principle has discovered the existence of the time rate of change of the internal momentums of solid-fluid bodies and naturally returned them to the fundamental laws of motion. Therefore, the self-action principle does not contradict Newton's laws of motion, but has naturally generalized them for a wider class of bodies by including the internal momentums of the bodies in the laws. In other words, the mechanics of solid-fluid bodies is a natural generalization of Newton's mechanics of solid bodies.

One of the important consequences of the original Newton's laws of motion is the conservation law for momentum. For solid-fluid bodies its counterpart can be obtained from Eq. (530). If the total of external forces vanishes from Eq. (530) we have

$$\begin{matrix}{{p}^{->}}_{ext} + {{p}^{->}}_{int} = cont or & ( 532 ) \\ \frac{ⅆ}{ⅆ t} {{p}^{->}}_{ext} = - \frac{ⅆ}{ⅆ t} {{p}^{->}}_{int} & ( 533 )\end{matrix}$$

Eqs. (532) and (533) allow us to formulate the following

CONSERVATION LAW FOR MOMENTUM OF A SOLD_FLUID BODY: If the total of external forces is zero, the total of external and internal momentums of a solid-fluid body is conserved or the time rate of change of its external momentum is equal and opposite to the time rate of change of its internal momentum.

We again see that the conservation law for momentum of a solid body based on the original Newton's laws of motion is a special case of the conservation law for momentum of a solid-fluid body when its fluid is absent or its total internal momentum is constant. The conservation law for momentum of a solid-fluid body is also a consequence of the self-action principle or momentum equation of a solid-fluid body. Therefore, the self-action principle does not contradict the conservation law for momentum of a solid body based on the original Newton's laws of motion, but has naturally generalized it for a wider class of bodies by including the internal momentums of the bodies in the law.

We now can apply the self-action principle or its consequences to the correct analysis of mobile object 40. The symbols for the pressures used in the analysis are the same as shown in FIG. 5.

It is obvious that the force due to the pressure and shear stress distributions over the side surface of generator chamber 48 vanishes. The forces due to the pressure distributions p₅ and p₆ over the internal and external side surfaces of circumferential tube 68 respectively also vanish due to their symmetry through the axis of shaft 56. Suppose when rotor 54 is at rest the pressure, p₀, density, ρ₀, temperature, T₀, and total mass, m₀, or volume, v₀, of the gas in generator chamber 48 are known. We assume that when rotor 54 rotates with angular velocity ω the gas exhausted out of the rotor is compensated momentarily and the clearance between open bottom 72 and the upper surface of disk-stator 52 is such small that the gas inside rotor 54 can be considered almost as in relative equilibrium. In that case the pressure equation of the gas inside rotor 54 is

$$\frac{ⅆ {p}_{2} ( r )}{ⅆ r} = {ρ}_{2} {ω}^{2} r = \frac{{ω}^{2}}{{RT}_{0}} {p}_{2} ( r ) r \qquad ( 534 )$$

where the positive direction of r is taken outward from the axis of shaft 56. Solving Eq. (534) gives

$${p}_{2} ( r ) = {p}_{2} ( 0 ) {ⅇ}^{\frac{{ω}^{2} {r}^{2}}{2 {RT}_{0}}} \qquad ( 535 )$$

Eq. (535) shows that the pressure inside rotor 54 depends not only on angular velocity ω, but also the pressure that is supported at the shaft inside rotor 54, i.e. P₂(0).

The gas mass, mᵣ, inside rotor 54 can be found by the integral

$${m}_{r} = {\int }_{0}^{{R}_{r}} 2 π h {ρ}_{2} ( r ) r ⅆ r = \frac{2 π {hp}_{2} ( 0 )}{{RT}_{0}} {\int }_{0}^{{R}_{r}} r {ⅇ}^{\frac{{ω}^{2} {r}^{2}}{2 {RT}_{0}}} ⅆ r$$

where Rᵣ and h are the radius and height of the rotor respectively. The integral gives

$${m}_{r} = \frac{2 π h {p}_{2} ( 0 )}{{ω}^{2}} ( {ⅇ}^{\frac{{ω}^{2} {R}_{r}^{2}}{2 {RT}_{0}}} - 1 ) \qquad ( 536 )$$

In the above integral and hereafter we ignore the radius of the shaft because of its smallness. Therefore, the above integral is taken from zero, but not from the radius of the shaft.

When the rotor rotates, the gas mass, m, outside the rotor is

$$m = {m}_{0} - {m}_{r} = {m}_{0} - \frac{2 {π hp}_{2} ( 0 )}{{ω}^{2}} ( {ⅇ}^{\frac{{ω}^{2} {R}_{r}^{2}}{2 {RT}_{0}}} - 1 ) \qquad ( 537 )$$

Then the average density of the gas outside the rotor is

$$ρ = \frac{m}{{v}_{0} - π {R}_{r}^{2} h} \qquad ( 538 )$$

where

$${v}_{0} = \frac{{m}_{0}}{{ρ}_{0}}$$

is the volume of the gas.

If q is the coefficient of compensation of the gas inside rotor 54 at the shaft, the pressure p₂(0) at the shaft is
p₂(0)=qp=pρRT₀ (539)

Solving the system of Eqs. (537)-(539) we obtain

$$\begin{matrix}ρ = \frac{{m}_{0}}{{v}_{0} - π {R}_{r}^{2} h + 2 π hqD ( E - 1 )} & \\ where & \\ D = \frac{{RT}_{0}}{{ω}^{2}} , & E = {ⅇ}^{\frac{{ω}^{2} {R}_{r}^{2}}{2 {RT}_{0}}}\end{matrix} \qquad ( 540 )$$

Since m₀=ρ₀ν₀, p₀=ρ₀RT₀, and p=ρRT₀, we have

$$p = \frac{{p}_{0} {v}_{0}}{{v}_{0} - π {R}_{r}^{2} h + 2 π hqD ( E - 1 )} \qquad ( 541 )$$

We suppose that the upper surfaces of disk 70 and disk-stator 52 are such smooth that the gas flows over them can be considered as inviscid. The force due to the pressure distribution over the surfaces of the dividing walls must be zero, since the gas inside rotor 54 is in relative equilibrium. Then according to Eq. (513) the self-action force of mobile object 40 is

$${\vec{F}}_{8} = {m}_{0} \vec{a} + {\sum }_{i = 1}^{4} {\vec{F}}^{( {p}_{1} )} - {m}_{0} \vec{f} \qquad ( 542 )$$

For calculation of the force \vec{F}^{(p}^{₁}⁾ we consider an infinitesimal ring having the width dr and the inner radius r on the upper surface of the top end of the rotor. The area of the ring is dS=2πrdr. Then the force acting upon the ring due to pressure p₁ is
d\vec{F}^{(p}^{₁}⁾(r)=−\hat{k}2πp₁(r)rdr (543)
where \hat{k} is the unit vector of z-axis, which coincides with the axis of the shaft of the rotor.

We suppose the process is adiabatic, i.e. we do not provide or extract heat from the mobile object. Then we can use the energy equation and isentropic relationship for isentropic calorically perfect gas flows

$$\begin{matrix}{C}_{p} {T}_{1} ( r ) + \frac{{V}_{1}^{2} ( r )}{2} = {C}_{p} {T}_{0} & ( 544 ) \\ \frac{{p}_{1} ( r )}{p} = {( \frac{{T}_{1} ( r )}{{T}_{0}} )}^{\frac{γ}{γ - 1}} & ( 545 )\end{matrix}$$

where p and T₀ are the pressure and temperature of the gas above the ring of radius r, and V₁(r)=ωr. From Eqs. (544) and (545) we obtain

$${p}_{1} ( r ) = {p ( 1 - \frac{{ω}^{2} {r}^{2}}{2 {C}_{p} {T}_{0}} )}^{\frac{γ}{γ - 1}} \qquad ( 546 )$$

Substituting formula (546) for p₁(r) in the right side of Eq. (543) gives

$$d {\vec{F}}^{( {p}_{1} )} ( r ) = - \hat{k} 2 π {p ( 1 - \frac{{ω}^{2} {r}^{2}}{2 {C}_{p} {T}_{0}} )}^{\frac{γ}{γ - 1}} r ⅆ r \qquad ( 547 )$$

Summing the increments d\vec{F}^{(p}^{₁}⁾(r) along the radius r from 0 to Rₗ. gives

$${\vec{F}}^{( {p}_{1} )} = - \hat{k} 2 π p {\int }_{0}^{{R}_{r}} {( 1 - \frac{{ω}^{2} {r}^{2}}{2 {C}_{p} {T}_{0}} )}^{\frac{γ}{γ - 1}} r ⅆ r \qquad ( 548 )$$

From the integrand of Eq. (548) we see that if

$$B = \frac{{ω}^{2} {R}_{r}^{2}}{2 {C}_{p} {T}_{0}} < 1 \qquad ( 549 )$$

we can apply the binominal coefficients for the integrand. Taking the four fist coefficients gives

$${\vec{F}}^{( {p}_{1} )} = - \hat{k} 2 π p {\int }_{0}^{{R}_{r}} ( r - \frac{γ}{2 ( γ - 1 )} \frac{{ω}^{2} {r}^{3}}{{C}_{p} {T}_{0}} + \frac{γ}{8 {( γ - 1 )}^{2}} \frac{{ω}^{4} {r}^{5}}{{C}_{p}^{2} {T}_{0}^{2}} - \frac{γ ( 2 - γ )}{48 {( γ - 1 )}^{3}} γ \frac{{ω}^{6} {r}^{7}}{{C}_{p}^{3} {T}_{0}^{3}} ++ \frac{γ ( 2 - γ ) ( 3 - 2 γ )}{384 {( γ - 1 )}^{4}} \frac{{ω}^{8} {r}^{9}}{{C}_{p}^{4} {T}_{0}^{4}} ) ⅆ r \qquad ( 550 )$$

The integral yields

$${\vec{F}}^{( {p}_{1} )} = - \hat{k} π {pR}_{r}^{2} ( 1 - \frac{γ}{2 ( γ - 1 )} B + \frac{γ}{6 {( γ - 1 )}^{2}} {B}^{2} - \frac{γ ( 2 - γ )}{24 {( γ - 1 )}^{3}} {B}^{3} + \frac{y ( 2 - γ ) ( 3 - 2 γ )}{120 {( γ - 1 )}^{4}} {B}^{4} ) \qquad ( 551 )$$

For the force acting on the infinitesimal ring of width dr and inner radius r of the lower surface of top disk 70 due to pressure p₂ we have
d\vec{F}^{(p}^{₂}⁾(r)=\hat{k}2πp₂(r)rdr (552)

Replacing p₂(r) in Eq. (552) with expression (535) together with condition (539) gives

$$d {\vec{F}}^{( p2 )} ( r ) = \hat{k} 2 π qp {ⅇ}^{\frac{{ω}^{2} {r}^{2}}{2 {RT}_{0}}} r ⅆ r \qquad ( 553 )$$

Then the total aerodynamic force acting on the lower surface of top disk 70 is defined by summing the increments d\vec{F}^{(p}^{₂}⁾(r) along the radius from 0 to Rᵣ, we have

$${\vec{F}}^{( p2 )} = \hat{k} 2 π qp {\int }_{0}^{{R}_{r}} {ⅇ}^{\frac{{ω}^{2} {r}^{2}}{2 {RT}_{0}}} r ⅆ r \qquad ( 554 )$$

The integral yields
\vec{F}^{(p}^{₂}⁾=\hat{k}2πqpD(E−1) (555)

Further, the force acting on the infinitesimal ring of width dr and inner radius r of the upper surface of disk-stator 52 due to pressure p₃ is
d\vec{F}^{(p}^{₃}⁾(r)=−\hat{k}2πp₃(r)rdr (556)

Since the disk-stator is fixed, the relative velocity of the gas over its upper surface can be defined as V₃(r)=ωr² Moreover, the pressure above the ring of radius r of its upper surface must be p₂(r). Then by analogy to Eqs. (544)-(546) we obtain

$${p}_{3} ( r ) = {p}_{2} ( r ) {( 1 - \frac{{ω}^{2} {r}^{2}}{2 {C}_{p} {T}_{0}} )}^{\frac{γ}{γ - 1}} \qquad ( 557 )$$

Putting p₂(r) from Eq. (535) and condition (539) into Eq. (557) gives

$${p}_{3} ( r ) = qp {{ⅇ}^{\frac{{ω}^{2} {r}^{2}}{2 {RT}_{0}}} ( 1 - \frac{{ω}^{2} {r}^{2}}{2 {C}_{p} {T}_{0}} )}^{\frac{γ}{γ - 1}} \qquad ( 558 )$$

Substituting Eq. (558) into Eq. (556) gives

$$d {\vec{F}}^{( p3 )} ( r ) = - k2 π qp {{ⅇ}^{\frac{{ω}^{2} {r}^{2}}{2 {RT}_{0}}} ( 1 - \frac{{ω}^{2} {r}^{2}}{2 {C}_{p} {T}_{0}} )}^{\frac{γ}{γ - 1}} r ⅆ r \qquad ( 559 )$$

Summing the increments d\vec{F}^{(p}^{₃}⁾(r) along the radius r from 0 to Rᵣ gives

$${\vec{F}}^{( {p}_{3} )} = - \hat{k} 2 π qp {\int }_{0}^{{R}_{r}} {{ⅇ}^{\frac{{ω}^{2} {r}^{2}}{2 {RT}_{0}}} ( 1 - \frac{{ω}^{2} {r}^{2}}{2 {C}_{p} {T}_{0}} )}^{\frac{γ}{γ - 1}} r ⅆ r \qquad ( 560 )$$

If condition (549) is satisfied the integrand of Eq. (560) can be expanded by applying the binominal coefficients, we obtain

$${\vec{F}}^{( {p}_{3} )} = - \hat{k} 2 π qp {\int }_{0}^{{R}_{r}} {ⅇ}^{\frac{{ω}^{2} {r}^{2}}{2 {RT}_{0}}} ( r - \frac{γ}{2 ( γ - 1 )} \frac{{ω}^{2} {r}^{3}}{{C}_{p} {T}_{0}} + \frac{γ}{8 {( γ - 1 )}^{2}} \frac{{ω}^{4} {r}^{5}}{{C}_{p}^{2} {T}_{0}^{2}} - \frac{γ ( 2 - γ )}{48 {( γ - 1 )}^{3}} \frac{{ω}^{6} {r}^{7}}{{C}_{p}^{3} {T}_{0}^{3}} ++ \frac{γ ( 2 - γ ) ( 3 - 2 γ )}{384 {( γ - 1 )}^{4}} \frac{{ω}^{8} {r}^{0}}{{C}_{p}^{4} {T}_{0}^{4}} ) ⅆ r \qquad ( 561 )$$

Integrating the right side of Eq. (561) by parts we obtain

$$\begin{matrix}{{F}^{->}}^{( {p}_{3} )} = - \hat{k} 2 π q p D ( E - 1 - \frac{γ C}{2 ( γ - 1 )} [ ( {R}_{r}^{2} - 2 D ) E + 2 D ] + & ( 562 ) \\ \frac{γ {C}^{2}}{8 {( γ - 1 )}^{2}} [ ( {R}_{r}^{4} - 4 D {R}_{r}^{2} + 8 {D}^{2} ) E - 8 {D}^{2} ] - & \\ \frac{γ ( 2 - γ ) {C}^{3}}{48 {( γ - 1 )}^{3}} [ ( {R}_{r}^{6} - 6 D {R}_{r}^{4} + 24 {D}^{2} {R}_{r}^{2} - 48 {D}^{3} ) E + & \\ 48 {D}^{3} ] + \frac{γ ( 2 - γ ) ( 3 - 2 γ ) {C}^{4}}{384 {( γ - 1 )}^{4}} [ ( {R}_{r}^{8} - 8 D {R}_{r}^{6} + & \\ 48 {D}^{2} {R}_{r}^{4} - 192 {D}^{3} {R}_{r}^{2} + 384 {D}^{4} ) E - 384 {D}^{4} ] ) & \\ where & \\ C = \frac{{ω}^{2}}{{C}_{p} {T}_{0}} & ( 563 )\end{matrix}$$

Finally, the force due to the pressure acting upon the lower surface of disk-stator 52 is
\vec{F}^{(p}^{₄}⁾=\hat{k}πRᵣ²p (564)

We now determine the acceleration of mobile object 40 by putting the forces into Eq. (515). The last term in the right side of the equation vanishes because all the internal solid elements of the mobile object, i.e. their centers of mass, are stationary in relation to generator chamber 48. Then from Eq. (515) we obtain

$${a}^{->} = \frac{1}{M} ( {\sum }_{i = 1}^{4} {{F}^{->}}^{( {p}_{i} )} + {{F}^{->}}^{( e )} ) \qquad ( 565 )$$

where \vec{F}^{(e)} is the total external force acting on the solid elements of the mobile object.

Substituting formula (565) for the acceleration a in Eq. (542) yields

$${{F}^{->}}_{s} = ( 1 + \frac{{m}_{0}}{M} ) {\sum }_{i = 1}^{4} {{F}^{->}}^{( {p}_{i} )} + {m}_{0} ( \frac{{{F}^{->}}^{( e )}}{M} - {f}^{->} ) \qquad ( 566 )$$

In particular, when mobile object 40 is acted upon by a gravitational force, the body force of the gas, \vec{f}, equals to the acceleration of gravity, \vec{f}=\vec{g}, and the total external force acting on its solid elements equals to their total mass multiplied by the acceleration, \vec{F}^{(e)}=M\vec{g}. Then Eq. (565) becomes

$${a}^{->} = \frac{1}{M} {\sum }_{i = 1}^{4} {{F}^{->}}^{( {p}_{i} )} + {g}^{->} \qquad ( 567 )$$

and Eq. (566) becomes

$${{F}^{->}}_{s} = ( 1 + \frac{{m}_{0}}{M} ) {\sum }_{i = 1}^{4} {{F}^{->}}^{( {p}_{i} )} \qquad ( 568 )$$

Eq. (568) has proved that the self-action force of solid-fluid body 40 is defined by the pressure distributions over the lower and upper surfaces of top disk 70 and disk-stator 52. Moreover, since m₀<<M, i.e. the mass of the gas is very small in comparison with the total mass of the solid elements, the term

$$\frac{{m}_{0}}{M}$$

in Eq. (568) can be neglected. Then from Eq. (568) we obtain the formula for calculation of the self-action force of solid-fluid body 40

$${{F}^{->}}_{s} = {\sum }_{i = 1}^{4} {{F}^{->}}^{( {p}_{i} )} \qquad ( 569 )$$

where \vec{F}^{(p}^{₁}⁾, \vec{F}^{(p}^{₂}⁾, and \vec{F}^{(p}^{₃}⁾, and \vec{F}^{(p}^{₄}⁾ are defined by formulae (548), (555), (560), and (564) respectively. In the case when the angular velocity and radius of rotor 54 satisfy condition (549) \vec{F}^{(p}^{₁}⁾ and \vec{F}^{(p}^{₃}⁾ can be calculated by formulae (551) and (562) respectively.

For illustration we suppose that mobile object 40 is filled with air. Then we have γ=1.4 and Cₚ=1004.5 J/kg.K. Assume that the temperature and pressure of the air at rest in mobile object 40 are given by the values T₀=188K and p₀=1.01×10⁵ N/m², i.e. it equals to the pressure of the atmosphere at sea level. Putting the values of T₀ and Cₚ into unequalness (549) yields the condition for validity of Eqs. (551) and (562) for \vec{F}^{(p}^{₁}⁾ and \vec{F}^{(p}^{₃}⁾ respectively
ΩRᵣ<5800 (570)
where Ω is the angular velocity of rotor 54 in rounds per minute (r/min). The coefficient of compensation is chosen equal to unit, q=1. The volume of generator chamber 48 is 2 m² and the height of rotor 54 is 0.5 m. The values of the self-action force of mobile object 40 calculated by formula (569) for some values of the angular velocity and radius of rotor 54 are presented in table A. In the table the angular velocity is measured in r/min, the radius in meters, and the self-action force in Newtons.

In table A we see that force generator 42 with a relatively small radius (not greater than 1 m) of its rotor and at a not very high angular velocity (not greater than 5000 r/min) can produce a very large lift. Those skilled in the art know that a lift device of other type (rotor of airfoil blades, lift disk, etc. . . . ) with the same sizes can produce a much smaller lift. The reason is that the increases in relative velocity of the gas on the lower and upper surfaces of a lift device of other type are almost the same when its radius or angular velocity increases. In contrary, when the radius or angular velocity of the force generator increases only the relative velocity on its upper surfaces increases, since the gas on its lower surfaces is in relative equilibrium. Therefore, the force generator produces the

TABLE A
The self-action force of mobile object 40 in Newtons

| Ω/Rᵣ | 0.1 | 0.2 | 0.3 | 0.4 | 0.5 | 0.6 | 0.7 | 0,8 | 0.9 | 1.0 |
|---|---|---|---|---|---|---|---|---|---|---|
| 1000 | 2 | 34 | 172 | 543 | 1324 | 2741 | 5063 | 8591 | 13649 | 20557 |
| 1500 | 5 | 76 | 387 | 1222 | 2979 | 6156 | 11324 | 19087 | 30014 | 44544 |
| 2000 | 8 | 136 | 688 | 2175 | 5297 | 10914 | 19967 | 33340 | 51674 | 75134 |
| 2500 | 13 | 212 | 1076 | 3403 | 8278 | 16998 | 30876 | 50930 | 77474 | 109748 |
| 3000 | 19 | 306 | 1553 | 4909 | 11927 | 24388 | 43911 | 71339 | 106048 | 145591 |
| 3500 | 26 | 417 | 2118 | 6697 | 16250 | 33064 | 58904 | 93952 | 135875 | 179913 |
| 4000 | 34 | 545 | 2773 | 8774 | 21257 | 43006 | 75657 | 118054 | 165339 | 210266 |
| 4500 | 43 | 691 | 2520 | 11146 | 26963 | 54194 | 93927 | 142808 | 192801 | 243763 |
| 5000 | 53 | 855 | 4360 | 13823 | 33389 | 66604 | 113400 | 167249 | 216741 | 252435 |

maximum difference between the pressures of the gas acting on its lower and upper surfaces, i.e. maximum lift.

The values of the self-action force presented in table A were calculated for the fixed pressure at rest p₀=1.01×10⁵ N/m² in generator chamber 48. Formulae (569), (548), (560), and (564) together with formula (541) show that the self-action force of mobile object 40 is proportional to the pressure p₀. Therefore, the self-action force of mobile object 40 can be increased further due to increasing the pressure p₀ in generator chamber 48.

For the test of the self-action force produced by mobile object 40 its experimental model with the force generator having the rotor of 0.2 m radius and 0.15 m height has been built. An electrical motor of 3 kW was used for driving rotor 54. The self-action force was measured at angular velocity 3000 r/min. The measurement of the self-action force was implemented by a weighing-scale that measured the weight of the mobile object at rest and at angular velocity 3000 r/min. The volume of the generator chamber was 0.1 m³, 0.2 m³, and 0.5 m³. For the first experiment some holes of the disk-stator were made for creation of the natural passages of air without any compensating gas means. The produced self-action force oscillated between 200 Newtons and 300 Newtons. The produced self-action force was almost the same for the volume 0.1 m³, 0.2 m³, and 0.5 m³ of the generator chamber. In the second experiment the volume of the generator chamber was 0.5 m³, the angular velocity of the rotor was 3000 r/min, different fans in a fan duct were used for the air compensation for the sake of reduction of the amplitude of oscillation of the self-action force. With the more suitable fans the produced self-action force oscillated slightly around 300 Newtons.

For testing the force generator alone, the generator chamber of the above experimental mobile object was removed. The lift of the force generator oscillated also slightly around 300 Newtons, that is it remains almost the same as in the case of the closure of the force generator in the generator chamber. For another test a force generator having a rotor of 0.5 m radius and 0.45 m height has been built. An electrical motor 1.3 kW was used for driving its rotor. The lift of the force generator was measured at angular velocity 1400 r/min. A compressor was used for the air compensation. The lift of the force generator oscillated slightly around the value 2670 Newtons.

So far we have considered the dynamics of the mobile object with one force generator. In general, each mobile object can include a plurality of the force generators. Then its self-action force is the total of the forces produced by all of its force generators. For example, if the mobile object comprises L force generators and the mass of the gas is ignored, its self-action force is

$${{F}^{->}}_{s} = {\sum }_{j = 1}^{L} {{F}^{->}}_{sj} = {\sum }_{j = 1}^{L} {\sum }_{i = 1}^{4} {{F}^{->}}_{j}^{( {p}_{i} )} \qquad ( 571 )$$

where \vec{F}ₛⱼ is the force produced by jth force generator. Then the acceleration of the mobile object is

$${a}^{->} = \frac{1}{M} {\sum }_{j = 1}^{L} {\sum }_{i = 1}^{4} {{F}^{->}}_{j}^{( {p}_{i} )} + {g}^{->} \qquad ( 572 )$$

where M is the total mass of all the solid elements of the mobile object and \vec{g} is the gravitational acceleration.

If mobile object 40 operates in the atmosphere and the working gas is the air at the atmospheric pressure, the earth's atmosphere can serve as a generator chamber of mobile object 40. In that case shell 100 may be removed or the generator chamber needs not to be pressurized. In FIGS. 1 and 4 rotor 54 has four dividing walls. In general, the number of dividing walls of the rotor may be chosen arbitrary from the conditions of the strength and dynamic balance of the rotor. In FIGS. 1 and 2 force generator 42 has one fan in a fan duct. In general, the number of fans and, therefore, fan ducts, may be chosen arbitrary, provided they provide sufficient and almost momentary compensation of the exhausted gas. In FIG. 1 and 2 central tube 74 serves as an assembling member for assembly of shaft 56. The central tube may be not necessary if dividing walls 76 extend directly from the shaft. Fan 58 in fan duct 60 is a compensating gas means for pumping the working gas into the space bounded by rotor 54 and disk-stator 52 to compensate the amount of the working gas exhausted out of that space due to the centrifugal force. For speeding the compensation process a compressor may be used instead of the fan in the fan duct. In some applications a hole through the disk-stator may be used as a compensating gas means. In that case the gas is sucked into the interior space of the rotor through the hole by natural way. Shaft 56 of rotor 54 of mobile object 40 shown in FIG. 1 is supported by bearing arrangement in both sides of the rotor. They may be also supported by bearing arrangement in one side of the rotor.

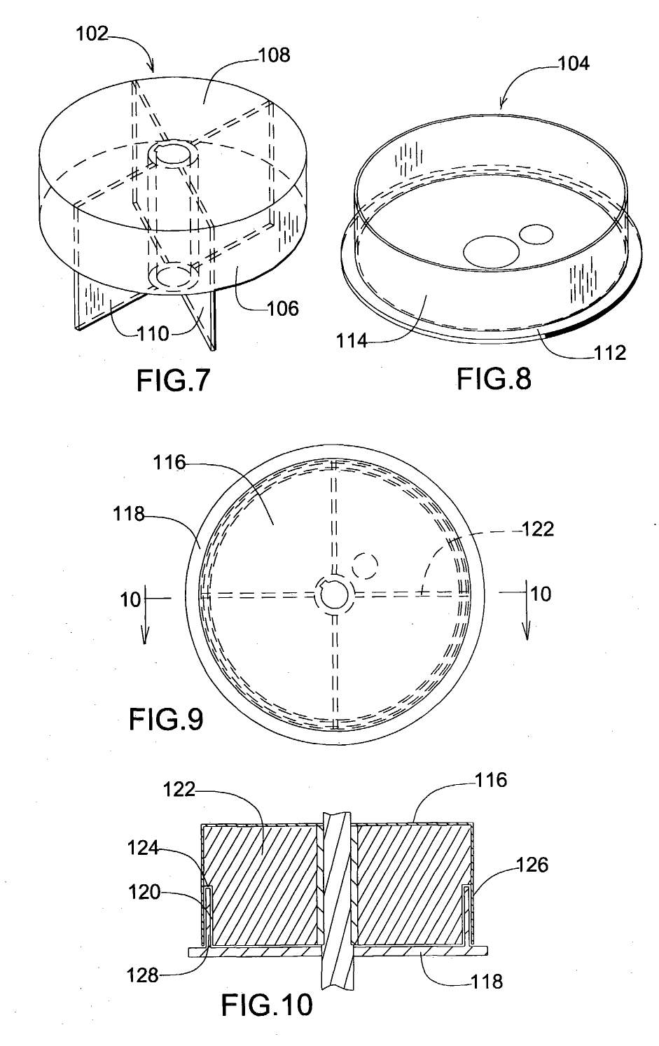

From the above consideration of operation of mobile object 40 and mathematical analysis of its dynamics we notice that force generator 42 produces the maximum difference between the pressures of the gas acting on its lower and upper surfaces, i.e. maximum lift, due to the special mutual structure of rotor 54 and disk-stator 52, which support the gas in relative equilibrium inside the rotor and under the disk-stator. For supporting the gas in relative equilibrium rotor 54 includes the two basic physical features that distinguish from the rotors of other lift devices. The first distinguished physical feature of rotor 54 is the rotary shell that is constituted of circumferential tube 68 and top disk 70 and has open bottom 72. The second distinguished physical feature of rotor 54 is a plurality of dividing walls that constitute a means supporting the gas in relative equilibrium inside the rotary shell during rotation of the shaft of rotor 54 when open bottom 72 is closed by disk-stator 52. The disk-stator is a stationary means that closes open bottom 72 for implementation of two functions. The first function of disk-stator 52 is to constrain the gas in the rotary shell during rotation of the shaft of rotor 54. The second function of disk-stator 52 is to produce the maximum difference between the pressures of the gas acting on its lower and upper surfaces, i.e. to support the gas on its lower surface in relative equilibrium. Thus disk-stator 52 is another distinguished physical feature of force generator 42 and together with rotor 54 constitute a mutual pair in the meaning of their geometric structure. The basic feature of the geometric structure of the mutual pair of rotor 54 and stator 52 is the division of the space bounded by the rotor and disk-stator into separate sections such that the separate sections rotate together with rotor 54 and the uncovered lower edges of dividing walls 76 skim the upper surface of disk-stator 52. The mutual structure of rotor 54 and stator 52 makes the working gas in the space bounded by the rotor and stator rotate together with rotor 54 and sweep over the upper surface of disk-stator 52. In other words, in the mutual structure the rotor is an accompanying gas means for accompanying a gas volume sweep over a part of the surface of the disk-stator. Therefore, the geometric structure of the mutual pair of the rotor and disk-stator can be modified provided they have the basic feature of the geometric structure. For example, the mutual pair of rotor 54 and disk-stator 52 may be replaced by the mutual pair of a rotor 102 and a stator 104 illustrated in FIGS. 7 and 8 respectively. In FIG. 7 rotor 102 has a circumferential tube 106, a top disk 108 and dividing walls 110. In FIG. 8 stator 104 has a disk 112 and a circumferential tube 114. Rotor 102 differs from rotor 54 by removing a lower part of circumferential tube 68, i.e. rotor 102 has circumferential tube 106 being shorter than circumferential tube 68. Stator 104 differs from disk-stator 52 by adding circumferential tube 114 to the upper surface of the disk-stator such that the added circumferential tube 114 fits the removed lower part of circumferential tube 68. FIGS. 9 and 10 illustrate another mutual pair of a rotor 116 and stator 118. Rotor 116 differs from rotor 54 by removing an exterior end 120 of the lower part of dividing walls 122 to create a slit 124 between a circumferential tube 126 and each of dividing walls 122. Stator 118 differs from disk-stator 52 by adding a circumferential tube 128 such that the added tube 128 fits slit 124.

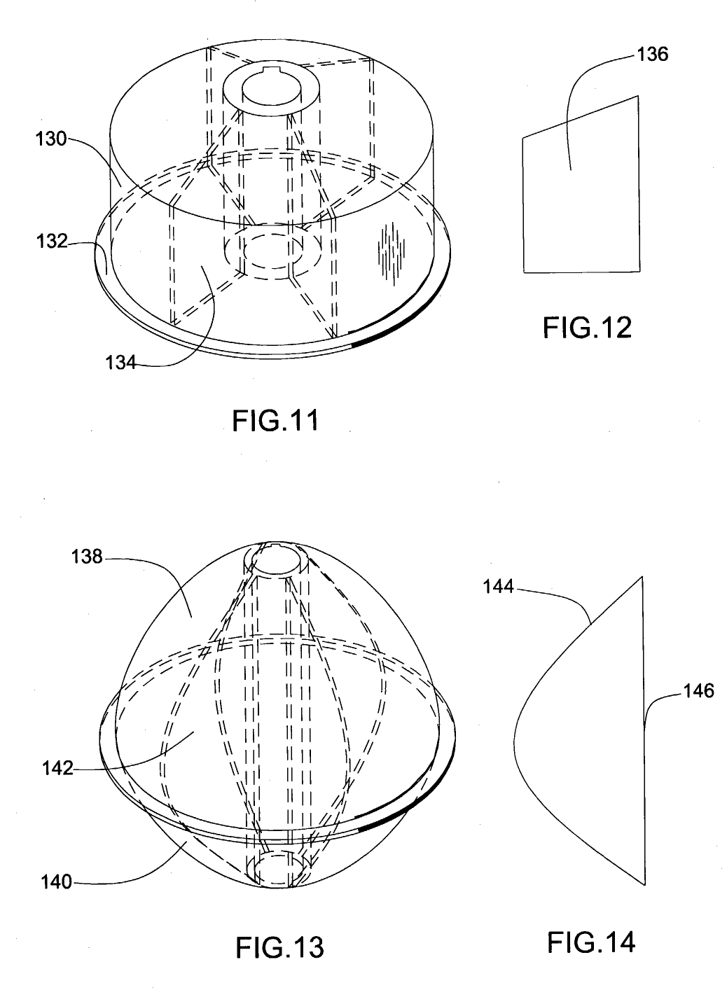

From the illustrated above pairs of rotor and stator we notice that each pair of a rotor and a stator can be constructed by the following way. The rotor includes a shaft, a shell, and a plurality of dividing walls. The shaft has bearing supporters being secured to the generator frame. The dividing walls extend from the shaft and an upper part of the surface swept by the edges of the dividing walls due to their rotation about the axis of the shaft is covered by the shell (the upper part may include the full outer edges of the dividing wall and even a apart of the bottom edges). The shaft may be separate and the rotor has an assembling member for assembly of the shaft. The surface swept by the uncovered part of the edges of the dividing walls due to their rotation about the axis of the shaft forms an open rotary surface of the rotor. The stator is a rigid member and has a fitting surface, which is a part of the surface of the stator that fits the open rotary surface of the rotor. The stator is secured to the generator frame and located under the rotor. The clearance between the open rotary surface of the rotor and the fitting surface of the stator is such small that the space bounded by the rotor and stator is divided into separate sections rotating about the axis of the shaft and the uncovered part of the edges of the dividing walls skims the fitting surface of the stator to accompany the working gas filling the space bounded by the rotor and the stator during rotation of the rotor. Whereby the working gas filling the space bounded by the rotor and the stator rotates together with the rotor and sweeps over the fitting surface of the stator during rotation of the rotor. For example, in the mutual pair of rotor 102 and stator 104 illustrated in FIGS. 7 and 8 each dividing wall 110 has a form of a rectangular plate. The shell includes circumferential tube 106 covering an upper part of the outer edges of the dividing walls and top disk 108 covering the upper end of circumferential tube 106 or the top edges of dividing walls 110. The remained uncovered part of the surface obtained by rotation of each dividing wall 110 about the axis of the shaft of rotor 102 is the open rotary surface of rotor 102. The interior surface of circumferential tube 114 and the part of the upper surface of disk 112 bounded by the bottom circumference of circumferential tube 114 constitute the fitting surface of stator 104 that fits the open rotary surface of rotor 102. During rotation of rotor 102 the uncovered part of the edges of dividing walls 110 skims the fitting surface of stator 104. For the other example, in the mutual pair of rotor 116 and stator 118 illustrated in FIGS. 9 and 10 the shell of rotor 116 also covers only an upper part of the edges of dividing walls 122, since slit 124 exists between the remained uncovered part of the edges of the dividing walls and the lower part of circumferential tube 126. Therefore, the open rotary surface of rotor 116 consists of the part of the surface swept by exterior edge 120 of the lower uncovered part of each dividing wall 122 due to its rotation about the axis of rotor 116 and the uncovered bottom surface of the rotor. Then the fitting surface of stator 118 consists of the interior surface of circumferential tube 128 and the part of the upper surface of the disk of the stator bounded by the bottom circumference of circumferential tube 128. We notice that the geometric shape of each mutual pair of a rotor and a stator is defined by the form of dividing walls of the rotor. FIG. 11 illustrates the geometric shape of the mutual pair of a rotor 130 and a disk-stator 132, which is defined by dividing walls 134 having the form of a trapezium 136 shown in FIG. 12. FIG. 13 illustrates the geometric shape of the mutual pair of a rotor 138 and a stator 140, which is defined by dividing walls 142 having the form consisting of a curve 144 and a straight line 146 shown in FIG. 14.

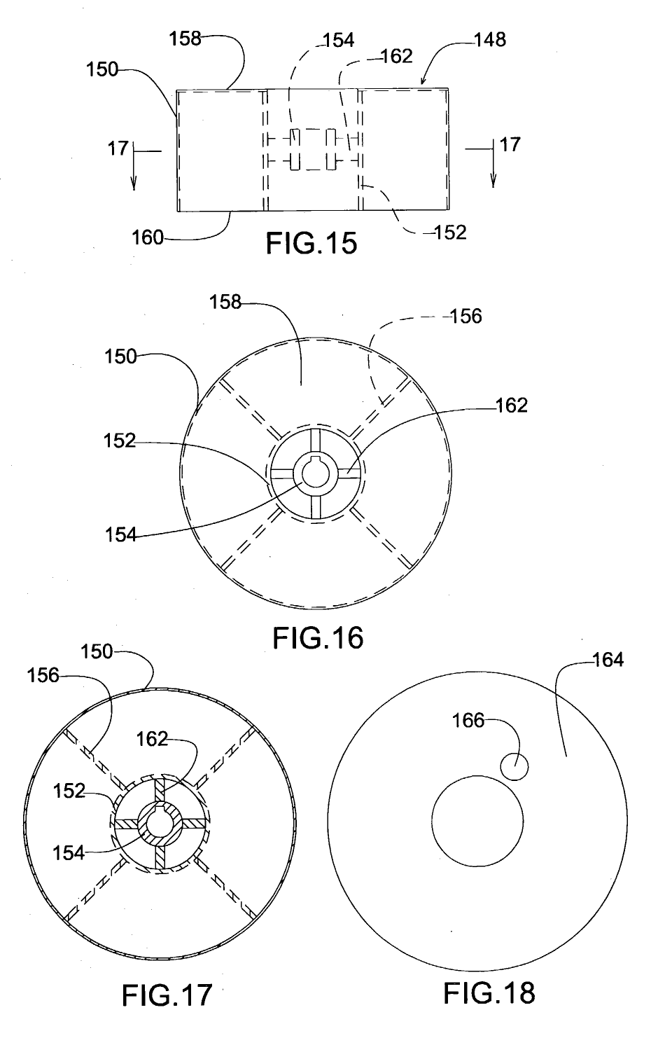

In FIG. 6 we see that the difference in pressure on the surfaces at small radius is much smaller than that at large radius. Therefore, if the radius of a rotor is very large the central tube of the rotor may be made with a large radius too. In that case the hole of the central tube for the shaft assembly may be made shorter in order to reduce the weight of the rotor. Then the rotor has a ring cross-section. FIGS. 15 and 16 illustrate a schematic side view and a schematic top plan view of a ring-rotor 148, which is a modification of the rotor shown in FIG. 4. The cross-section perpendicular to the shaft of rotor 148 has a ring shape shown in FIG. 17. In the figures ring-rotor 148 has a circumferential tube 150, a central tube 152, a shaft tube 154 for the shaft assembly, dividing walls 156, a top ring 158 and an open bottom 160. Dividing walls 156 extend from central tube 152 to circumferential tube 150 and from top ring 158 to open bottom 160. Thus dividing walls 156 divide the space bounded by circumferential tube 150 and central tube 152 into separate sections. Central tube 152 is secured to shaft tube 154 by rods 162. A ring-stator 164 shown in FIG. 18 together with ring-rotor 148 constitute their mutual pair. Ring-stator 164 has also a hole 166 for the outlet opening of a compensating gas means.

We notice that if disk-stator 52 of force generator 42 of mobile object 40 of FIG. 1 is removed, the difference in pressure distribution over the lower and upper surfaces of top disk 70 of rotor 54 still exists. Therefore, if generator chamber 48 is high enough such that the pressures at its ceiling and floor remain almost equal to the static pressure P0 during rotation of rotor 54 with disk-stator 52 removed, mobile object 40 still generates its self-action force. Of course the force generated by the rotor with the stator removed is too much smaller than the force generated by the force generator with the mutual pair the rotor and stator. The situation remains true for other types of rotor. Nevertheless, one special case is very interesting and useful. In that case a rotor of blades having an airfoil cross-section and being installed in a pressurized chamber can be used as a force generator.

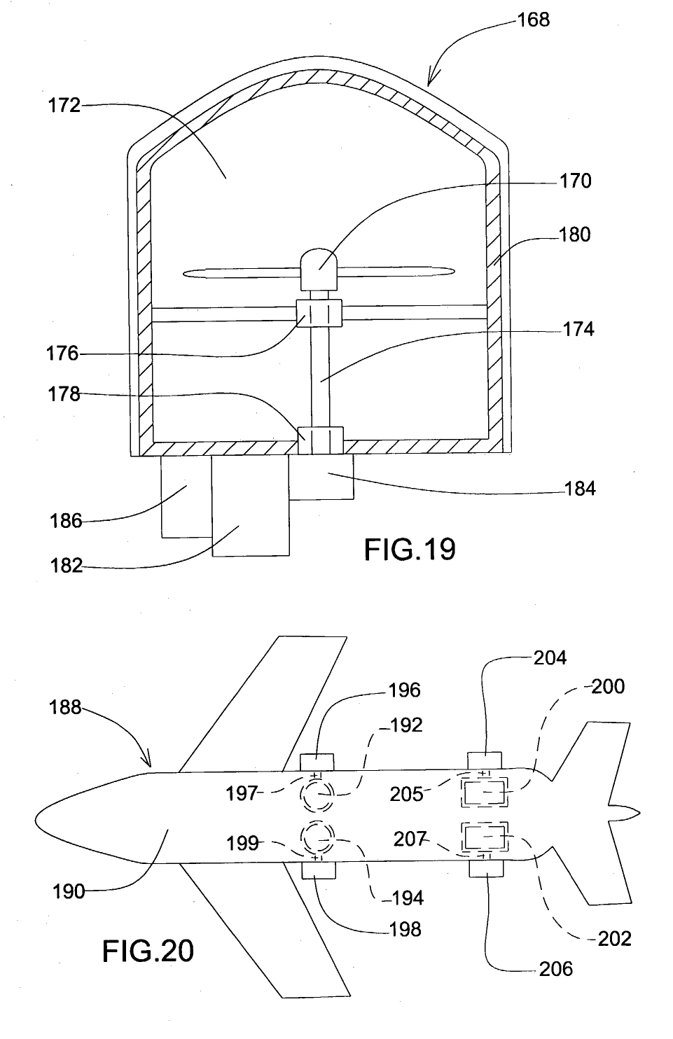

FIG. 19 illustrates a mobile object, indicated generally at 168, with a rotor of blades 170 having an airfoil cross-section and being installed in a hermetically sealed generator chamber 172. Rotor of blades 170 has a shaft 174, which is supported for rotation by bearing supporters 176 and 178. Bearing supporters 176 and 178 are secured to a structural frame 180 of mobile object 168. Shaft 174 of rotor of blades 170 is operatively connected to an engine 182 by a gearbox 184. A pump system 186 pressurizes a gas in generator chamber 172. Pump system 186 is powered from engine 182. Generator chamber 172 should be high enough such that the rotation of rotor 170 almost does not influence on the pressures at its ceiling and floor.

In operation, rotor of blades 170 is driven from engine 182 through gearbox 184. Then the aerodynamic force or the lift created by rotor 170 can get a sufficiently large value due to the high pressure in generator chamber 172 and high angular velocity of rotor 170. That force acts on the whole body of mobile object 168 through the shaft, mechanical joints, fasteners, supporters, and structural frame of the mobile object. Thus mobile object 168 generates its self-action force that also does not depend on the outer environment surrounding the mobile object. Mobile object 168 distinguishes from conventional helicopters by the independence of its self-action force from outer environment and the possibility of the operation of rotor 170 at high pressure that allows reducing the size of its blades and increasing its angular velocity.

We now apply the self-action principle presented earlier to the correct analysis of the dynamics of mobile object 168.

Since the gas is compressible we write its equation in relative equilibrium in the form

$$\frac{ⅆ p}{ⅆ z} = - \frac{a}{RT} p \qquad ( 573 )$$

The solution of the equation is

$$p ( z ) = {p}_{1} {ⅇ}^{- \frac{a}{RT} z} \qquad ( 574 )$$

where p₁ is the pressure of the gas on the floor of generator chamber 172. If p₀ is the density of the gas at rest, then due to the conservation of mass we have

$${ρ}_{0} Al = {\int }_{0}^{l} A ρ ( z ) ⅆ z = {\int }_{0}^{l} \frac{{Ap}_{1}}{RT} {ⅇ}^{- \frac{a}{RT} z} ⅆ z = - \frac{{Ap}_{1}}{a} ( {ⅇ}^{- \frac{a}{Rt} l} - 1 ) \qquad ( 575 )$$

where l is the average height of generator chamber 172. From Eq. (575) we have

$${p}_{1} = - \frac{l {ρ}_{0} a}{( {ⅇ}^{- \frac{a}{RT} l} - 1 )} \qquad ( 576 )$$

Substituting formula (576) for p₁ in Eq. (574) yields

$$p ( z ) = \frac{l {ρ}_{0} a}{( {ⅇ}^{- \frac{a}{RT} l} - 1 )} {ⅇ}^{- \frac{a}{Rt} z} \qquad ( 577 )$$

From Eq. (577) we obtain the difference in pressure between the ceiling and floor
p₂−p₁=−lρ₀a (578)

Then the force due to the pressure distributions over the ceiling and floor is
\vec{F}^{(p}^{₁}⁾+\vec{F}^{(p}^{₂}⁾=−\hat{k}Alρ₀a=−m₀\vec{a} (579)

It is obvious that the total force due to the pressure and shear stress distributions over the walls of mobile object 168 vanishes. The force due to the pressure and shear stress distributions over the surfaces of blades of rotor 170 is its aerodynamic lift, \vec{L}_{R}. Then according to Eq. (513) the self-action force of mobile object 168 is
\vec{F}ₛ=m₀\vec{a}+\vec{F}^{(p}^{₁}⁾+\vec{F}^{(p}^{₂}⁾+\vec{L}_{R}−m₀\vec{f}=\vec{L}_{R}−m₀\vec{f} (580)

The last term in the right side of Eq. (515) vanishes, since the center of mass of rotor 170 is at rest in relation to generator chamber 172. Therefore, putting the corresponding forces into Eq. (515) gives
M\vec{a}=\vec{F}^{(p}^{₁}⁾+\vec{F}^{(p}^{₂}⁾+\vec{L}_{R}+\vec{F}^{(e)}=−m₀\vec{a}+\vec{L}_{R}+\vec{F}^{(e)} (581)
where \vec{F}^{(e)} is the total external force acting on all the solid elements of the mobile object.

From Eq. (581) we obtain the acceleration of mobile object 168

$${a}^{->} = \frac{{{L}^{->}}_{R} + {{F}^{->}}^{( e )}}{{m}_{0} + M} \qquad ( 582 )$$

In particular, when mobile object 168 is acted upon by a gravitational force, the body force of the gas, \vec{f}, equals to the acceleration of gravity, \vec{f}=\vec{g}, and the total external force is \vec{F}^{(e)}=M\vec{g}. Then Eqs. (580) and (582) become

$$\begin{matrix}{{F}^{->}}_{s} = {{L}^{->}}_{R} - {m}_{0} {g}^{->} and & ( 583 ) \\ {a}^{->} = \frac{{{L}^{->}}_{R} + M {g}^{->}}{{m}_{0} + M} & ( 584 )\end{matrix}$$

Formula (583) shows that the self-action force of mobile object 168 is almost equal to the lift \vec{L}_{R} of rotor 170, since the mass m₀ of the gas is very small in comparison with the mass of the mobile object and the gravitational force acting on the gas is very small in comparison with the lift of the rotor.

For testing the self-action force of mobile object 168, the cross-section of the blades of rotor 170 was chosen such that the lift of rotor 170 was created only by the difference between the pressures of the gas acting on the lower and upper surfaces of the blades and the volume of the gas flowing downward during rotation of the rotor was as small as possible. With such cross-section of the blades, the self-action force of mobile object 168 was almost equal to the lift of rotor 170 when the height of generator chamber 172 was greater than three times of the radius of the rotor. When the height of generator chamber 172 decreased, the self-action force of mobile object 168 also decreased and was less than the lift of rotor 170.

Formulae (583) and (584) show that the self-action force and acceleration of mobile object 168 are fully defined by the lift \vec{L}_{R} of rotor 170 in the case of absence of gravitational force. Those skilled in the art know that the lift of a lift device increases when the pressure of the working gas increases. Therefore, the self-action force of mobile object 168 can be increased as many times as desirable by increasing the pressure of the gas inside generator chamber 172.

Mobile object 40 can accompany a body or a vehicle. Then the motion direction of the vehicle can be controlled by controlling the direction of the shaft of the force generator of the mobile object. In order to cancel the reactive moment of the rotor of the force generator it is desirable to install in the generator chamber two identical force generators rotating in opposite directions. The value of the force generated by each force generator can be controlled by controlling the angular velocity of its rotor due to regulating the angular velocity of its driving engine and a brake (not shown) for braking its rotor in necessary situations. In general, each vehicle can be equipped with a plurality of the force generators and a space inside the vehicle can be used as a generator chamber of its force generators.

FIG. 20 illustrates a mobile object indicated generally at 188, which is a conventional aircraft equipped with the force generators for vertical take-off and landing. Mobile object 188 comprises an aircraft 190 of any type, two identical force generators 192 and 194, which are powered from engines 196 and 198 respectively. Engines 196 and 198 are mounted to the structural frame of the body of aircraft 190 outside the body thereof. Force generators 192 and 194 are vertically (with the vertical upward direction of generated forces) mounted inside the body of aircraft 190 and rotate in opposite directions. The shafts of the rotors of force generators 192 and 194 are operatively connected to engines 196 and 198 by mechanical transmission means 197 and 199 respectively. The air inside the body of the aircraft is used as the working gas for the force generators. Force generators 192 and 194 may be also powered from engines (not shown) of aircraft 190 if its engines are turbo-fan or turbo-prop. However, from the point of view of high safety for flying, force generators 192 and 194 are better powered from their own engines as shown in FIG. 20. Since the air inside the body of the aircraft is used as the working gas, force generators 192 and 194 and engines 196 and 198 may be installed in any suitable location of aircraft 190.

In operation, force generators 192 and 194 are driven from engines 196 and 198 through mechanical transmission means 197 and 199 respectively. The angular velocity of engines 196 and 198, therefore and force generators 192 and 194, are controlled by a control system (not shown) mounted in the cockpit (not shown) of aircraft 190. During take-off force generators 192 and 194 lift aircraft 190 to a necessary height before starting its horizontal motion. During flying force generators 192 and 194 may be at rest or used to increase the height of the fly if it is necessary. During landing the force generators are controlled to provide a smooth vertical landing.

Mobile object 188 may be also equipped with force generators mounted horizontally (with horizontal orientation of their axes) for propulsion. In FIG. 20 force generators 200 and 202 are identical and mounted horizontally inside aircraft 190 for propulsion of mobile object 188. Force generators 200 and 202 are powered from engines 204 and 206 respectively and rotate in opposite directions. The shafts of the rotors of force generators 200 and 202 are operatively connected to engines 204 and 206 by mechanical transmission means 205 and 207 respectively.

The use of force generators for lifting and landing of a conventional aircraft allows not only to increase its safety in flying, but also to remove its wings. If the wings of aircraft 190 are removed, mobile object 188 can fly at any altitude that does not depend on its speed. In that case either a conventional propulsion mechanism (not shown) or force generators 200 and 202 are used for propulsion.

Mobile object 188 is an aircraft of the combination of the force generator's technology with the conventional technology.

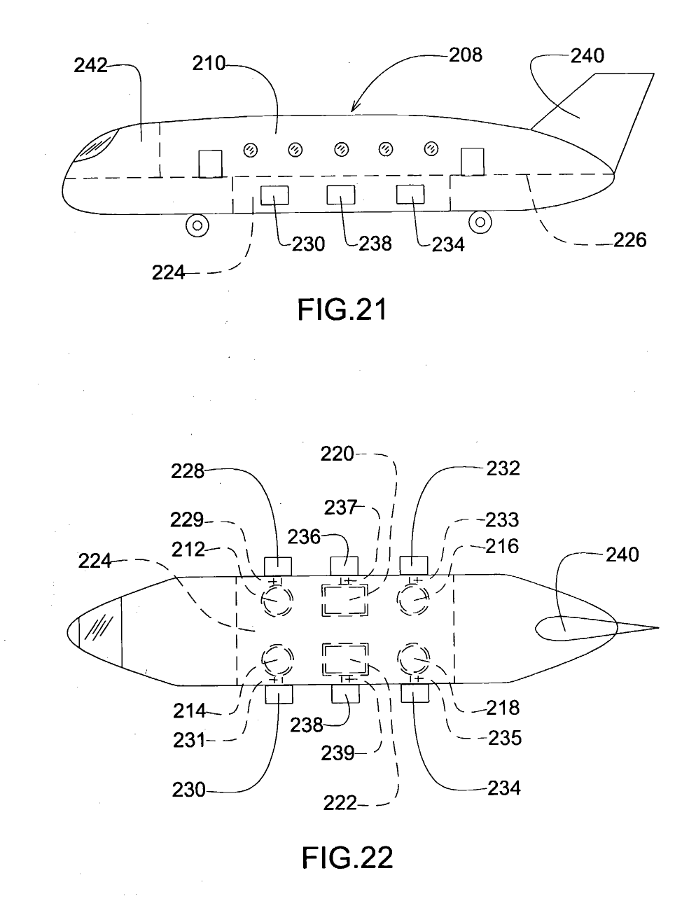

FIGS. 21 and 22 illustrate an alternative mobile object indicated generally at 208, which comprises a conventional aircraft with its wings removed 210 and is equipped with force generators 212, 214, 216, 218, 220, and 222. Force generators 212, 214, 216, and 218 are vertically mounted for lifting. Force generators 212 and 214 are identical and rotate in opposite directions. Force generators 216 and 218 are identical and rotate in opposite directions. Force generators 220 and 222 are identical, horizontally mounted for propulsion, and rotate in opposite directions. All the force generators 212, 214, 216, 218, 220, and 222 are installed in a generator chamber 224 located under a floor 226 of aircraft 210. The working gas in the generator chamber is the air. Force generators 212, 214, 216, 218, 220, and 222 are powered from engines 228, 230, 232, 234, 236, and 238 respectively. All the engines are mounted to the structural frame of the body of aircraft 210 outside the body thereof. The shafts of the rotors of force generators 212, 214, 216, 218, 220, and 222 are operatively connected to engines 228, 230, 232, 234, 236, and 238 by mechanical transmission means 229, 231, 233, 235, 237, and 239 respectively. Mobile object 208 includes also a rudder 240.

In operation, force generators 212, 214, 216, 218, 220, and 222 are driven from engines 228, 230, 232, 234, 236, and 238 through mechanical transmission means 229, 231, 233, 235, 237, and 239 respectively. The angular velocities of engines 228, 230, 232, 234, 236, and 238, therefore and force generators 212, 214, 216, 218, 220, and 222 are controlled by a control system (not shown) mounted in a cockpit 242 of aircraft 210. Force generators 212, 214, 216, and 218 are used for lifting and landing. Force generators 220 and 222 are used for propulsion. Mobile object 208 yaws by controlling horizontally mounted force generators 220 and 222. Controlling the difference between the forces generated by force generator 220 and force generator 222 creates a necessary moment to yaw mobile object 208 to the right or to the left. Mobile object 208 can also yaw by controlling rudder 240. Mobile object 208 pitches by controlling vertically mounted force generators 212, 214, 216, and 218. Controlling the difference between the total force generated by fore force generators 212 and 214 and the total force generated by backward force generators 216 and 218 creates a necessary moment to pitch mobile object 208 upwards or downwards. Mobile object 208 rolls by controlling vertically mounted force generators 212, 214, 216, and 218. Controlling the difference between the total force generated by right force generators 212 and 216 and the total force generated by left force generators 214 and 218 creates a necessary moment to roll mobile object 208 to the right or the left. Since the air density does not influence on the operation of the force generators, mobile object 208 can fly at any altitude.

A mobile object being a conventional vehicle such as an automobile, a train, a ship, or a submarine can be also equipped with the force generators like the conventionalaircrafts equipped with the force generators illustrated in FIGS. 20-22. The number of equipped force generators for each vehicle is arbitrarily chosen in depending on the size and weight of the vehicle and the force each installed force generator can generate. In each vehicle some force generators are horizontally mounted for propulsion and some others are vertically mounted for lifting or diving. The vertically mounted force generators in each automobile, train, or ship direct their forces upward for lifting. The vertically mounted force generators in each submarine direct their forces downward for diving. Thus the automobile, train and ship equipped with the force generators can carry heavier weight or move faster. The submarine equipped the force generators can dive deeper and much easier maneuver in the depth.

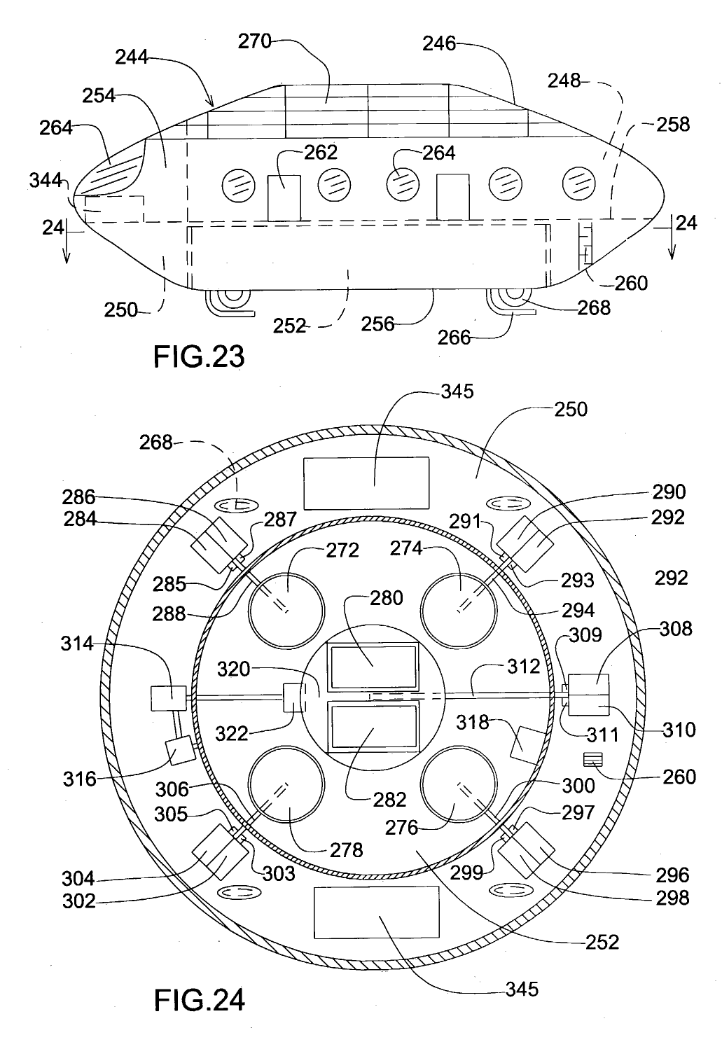

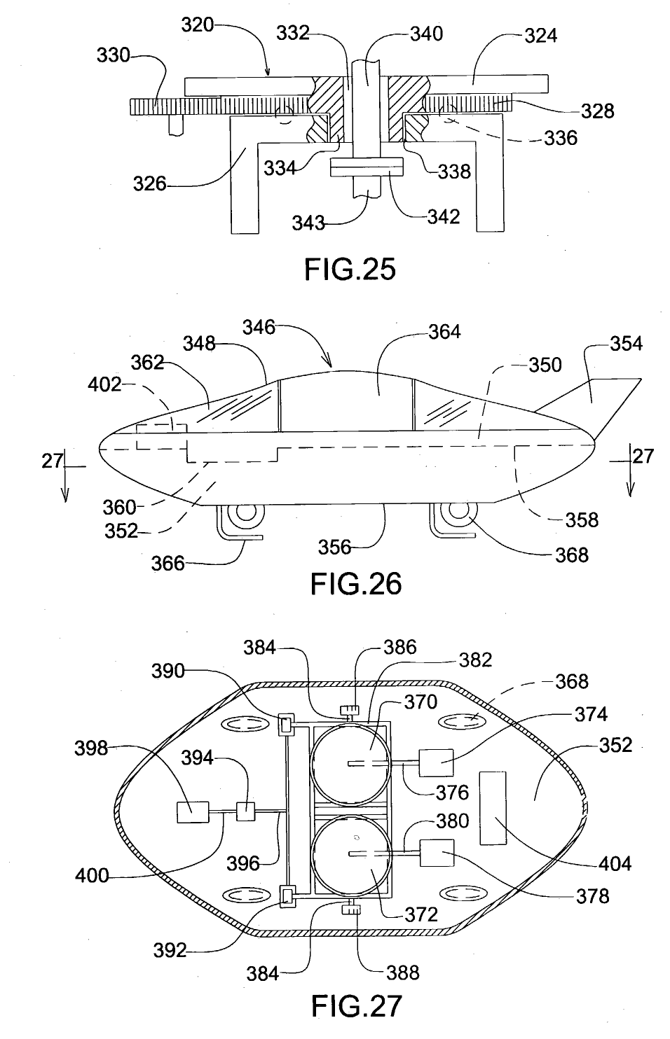

FIG. 23 illustrates a mobile object, indicated generally at 244, constructed in accordance with an alternative embodiment of the present invention. FIG. 24 is a schematic sectional view of mobile object 244 taken on line 24-24 in FIG. 23. Mobile object 244 has a flying saucer shaped body 246 and includes a passenger cabin 248, a machine cabin 250, a generator chamber 252 and a cockpit 254. The skin of body 246 is mounted to a structural frame 256. The skin may be covered with a special protecting material for cosmos traveling. Passenger cabin 248 has a horizontal floor 258, which behaves as a beam attached to structural frame 256 at its circumference. Machine cabin 250 has a ladder 260 for climbing up and down between cabins 248 and 250. Passenger cabin 248 has a plurality of doors 262, a plurality of screen windows 264. Mobile object 244 has suspension piers 266 for standing on the ground and wheels 268, which are able to lower for running on the ground when it is necessary. Mobile object 244 is also provided with photovoltaic panels 270 for generation of solar electricity, which can be extended by a mechanism (not shown) mounted under the panels. Generator chamber 252 is filled with the air and pressurized and contains force generators 272, 274, 276, 278, 280, and 282 (see FIG. 24). All the necessary supporters of the force generators are secured to structural frame 256. The shaft of the rotor of force generator 272 is operatively connected to an engine 284 or an electrical motor 286 by a mechanical transmission means 288. Engine 284 is connected to mechanical transmission means 288 by a means 285 selectively disengaging the engine, and electrical motor 286 is connected to mechanical transmission means 288 by a means 287 selectively disengaging the motor. The shaft of the rotor of force generator 274 is operatively connected to an engine 290 or an electrical motor 292 by a mechanical transmission means 294. Engine 290 is connected to mechanical transmission means 294 by a means 291 selectively disengaging the engine, and electrical motor 292 is connected to mechanical transmission means 294 by a means 293 selectively disengaging the motor. The shaft of the rotor of force generator 276 is operatively connected to an engine 296 or an electrical motor 298 by a mechanical transmission means 300. Engine 296 is connected to mechanical transmission means 300 by a means 297 selectively disengaging the engine, and electrical motor 298 is connected to mechanical transmission means 300 by a means 299 selectively disengaging the motor. The shaft of the rotor of force generator 278 is operatively connected to an engine 302 or an electrical motor 304 by a mechanical transmission means 306. Engine 302 is connected to mechanical transmission means 306 by a means 303 selectively disengaging the engine, and electrical motor 304 is connected to mechanical transmission means 306 by a means 305 selectively disengaging the motor. The shafts of the rotors of force generators 280 and 282 are operatively connected to an engine 308 or an electrical motor 310 by a mechanical transmission means 312. Engine 308 is connected to mechanical transmission means 312 by a means 309 selectively disengaging the engine, and electrical motor 310 is connected to mechanical transmission means 312 by a means 311 selectively disengaging the motor. Machine cabin 250 is also equipped with an auxiliary power unit 314 and a pump system 316 for pressurization of generator chamber 252 and passenger cabin 248. There is a special gateway 318 between machine cabin 250 and generator chamber 252. Force generators 272, 274, 276, and 278 are identical and vertically mounted for lifting. Force generators 272, 274, 276, and 278 are located at an equal distance from the central axis of the body of mobile object 244, and at an equal distance from each other. The direction of rotation of the shafts of force generators 272 and 274 and the direction of rotation of the shafts of force generators 276 and 278 are opposite. Force generators 280 and 282 are identical and mounted horizontally on a turntable 320. The shafts of force generators 280 and 282 are parallel, rotate in opposite directions and their generated forces have the same direction. The axis of turntable 320 coincides with the central axis of the body of mobile object 244. This means that the shafts of force generators 280 and 282 are parallel to floor 258, and the forces generated by force generators 280 and 282 have their direction perpendicular to the direction of the forces generated by force generators 272, 274, 276, and 278. Turntable 320 can turn on its axis any angle by the help of a control motor 322. A structure of turntable 320 is shown in FIG. 25. Turntable 320 includes a turning supporter 324 and a structural supporter 326. Turning supporter 324 is used for securing the frames of force generators 280 and 282. Structural supporter 326 is secured to structural frame 256 and used for supporting turning supporter 324. Turning supporter 324 has a gearwheel 328 underneath, which is driven for turning by a small gearwheel 330 of at gear train (not shown) driven from control motor 322. The control motor is powered from auxiliary power unit 314. Turntable 320 has a hole 332 at its center for the line of power transmission and a cylindrical shaft 334. Turning supporter 324 is supported on a suitable bearing 336 for rotation on structural supporter 326. Cylindrical shaft 334 rotates in a bore 338 of structural supporter 326. Suitable sleeve bearing may be provided in bore 338. For correct coordination of the operation of turntable 320 with the power transmission from engine 308 or electrical motor 310 to force generators 280 and 282 a shaft 340 rotating in hole 332 is jointed to a clutch 342 under the turntable. The flywheel of clutch 342 is jointed to a shaft 343, which is the output of mechanical transmission means 312. A control unit 344 including all the control panels and necessary steering tools of mobile object 244 is mounted in cockpit 254. All the necessary mechanical, hydraulic, and electrical transmission lines and circuits (not shown) connecting the control panels and steering tools of mobile object 244 with their objects such as the engines, actuators, motors, turntable, clutch, control motor, wheels and their brakes are mounted suitably in machine cabin 250 and generator chamber 252. For supplying fuel to the engines fuel tanks 345 together a system of pumps and valves (not shown) are arranged in machine cabin 250 so that the center of gravity of mobile object 244 as closer to its center of gravity as possible. Mobile object 244 may be also provided with external drop fuel tanks (not shown). Hydraulic-mechanical systems (not shown) for lowering and braking wheels 268 of the mobile object are powered from auxiliary power unit 314.

In operation, force generators 272, 274, 276, and 278 are driven from engines 284, 290, 296, and 302 through mechanical transmission means 288, 294, 300, and 306 respectively or electrical motors 286, 292, 298, and 304 through mechanical transmission means 288, 294, 300, and 306 respectively. Force generators 280 and 282 are driven from engine 308 or electrical motor 310 through mechanical transmission means 312. The angular velocities of engines 284, 290, 296, 302, and 308 or electrical motor 286, 292, 298, 304, and 310, therefore and force generators 272, 274, 276, 278, 280, and 282 are controlled by control unit 344. Force generators 272, 274, 276, and 278 lift mobile object 244 in the direction of the vertical axis of the mobile object. Force generators 280 and 282 thrust mobile object 244 in a direction perpendicular to the vertical axis of the mobile object. The instant direction of the thrusting force of force generators 280 and 282 is defined by the instant turning angle of turntable 320, which is controlled by control motor 322. Then mobile object 244 can implement any translation motion in space by combination of the lifting and thrusting forces. Mobile object 244 maneuvers by controlling the forces generated by force generators 272, 274, 276, 278, 280, and 282 to create necessary moments. Mobile object 244 rolls about the axis of symmetry between the pair of force generators 272 and 274 and the pair of force generators 276 and 278 by creation of the difference between the total force generated by force generators 272 and 274 and the total force generated by force generators 276 and 278. Mobile object 244 rolls about the axis of symmetry between the pair of force generators 272 and 278 and the pair of force generators 274 and 276 by creation of the difference between the total force generated by force generators 272 and 278 and the total force generated by force generators 274 and 276. Mobile object 244 rolls about the axis of symmetry between force generators 272 and 276 by creation of the difference between the force generated by force generator 272 and the force generated by force generator 276. Mobile object 244 rolls about the axis of symmetry between force generators 274 and 278 by creation of the difference between the force generated by force generator 274 and the force generated by force generator 278. Thus mobile object 244 can implement almost any maneuver in any direction in space by controlling force generators 272, 274, 276, 278, 280, and 282, and turntable 320. When mobile object 244 flies at very high altitude or in cosmos, solar energy converted to electrical energy by photovoltaic panels 270 can be used for powering electrical motors 286, 292, 298, 304, and 310. Particularly, in cosmos mobile object 244 can continue accelerate by using solar energy or universe energy up to desirable velocity and the fuel on board can be saved for emergencies. Since the value and direction of the self-action force can be controlled and do not depend on the air density, mobile object 244 can come out to the cosmos and return into the atmosphere smoothly.

Mobile object 244 shown in FIGS. 23 and 24 includes four vertically mounted force generators and two horizontally mounted force generators. In general, the number of equipped force generators and their arrangement in the mobile object can be chosen arbitrary. That depends on the characteristics of the equipped force generators and the mass, volume, and specific functions of the mobile object. For example, if force generators 274 and 278 of mobile object 244 are removed, the lift and the possibility of maneuver of the mobile object are reduced. For other example, if mobile object 244 is equipped with another additional pair of horizontally mounted force generators, the propulsion and the possibility of maneuver of the mobile object are larger. Since the forces generated by the force generators do not depend on the outer environment surrounding the mobile object, the shape of the body of the mobile object can be changed as desired. In other words, the shape of each mobile object equipped with force generators may be chosen arbitrary in depending on its specific purposes.

If a mobile object equipped with the force generators flies at a low altitude near the earth surface and its volume is desired to be as small as possible for a given passenger space, the number of the equipped force generators may be reduced by adding other members.

FIGS. 26 and 27 illustrate a mobile object, indicated generally at 346, which is a small vehicle flying near the earth surface and serves as a flying car. Mobile object 346 has a body of aerodynamic shape 348 and includes a pilot cabin 350, a machine cabin 352, and a rudder 354. The skin of body 348 is secured to a structural frame 356. Pilot cabin 350 has a horizontal floor 358, which behaves also as a beam attached to structural frame 356. Floor 358 may have a lower section 360 if the pilot cabin is too small. Pilot cabin 350 has a glass screen 362 for pilot vision. A door 364, which is a section of the top of the pilot cabin, has hinges (not shown) and can be closed-off for pilot climbing. Mobile object 346 has suspension piers 366 for standing on the ground and wheels 368, which are able to lower for running on the ground when it is necessary. Mobile object 346 is equipped with force generators 370 and 372 (see FIG. 27), which are arranged in machine cabin 352. Thus machine cabin 352 serves also as a generator chamber, since the natural air in the atmosphere is used as a working gas for the force generators. The shaft of the rotor of force generator 370 is operatively connected to an engine 374 by a mechanical transmission means 376. The shaft of the rotor of force generator 372 is operatively connected to an engine 378 by a mechanical transmission means 380. Engines 374 and 378 are mounted in machine cabin 352. Force generators 370 and 372 are identical and rotate in opposite directions. Force generators 370 and 372 are vertically mounted on the upper plane of a rectangular frame 382. Frame 382 has a shaft 384, which is supported by suitable bearings (not shown) arranged in struts 386 and 388. Struts 386 and 388 are secured to structural frame 356. One of the edges of frame 382 is operatively jointed with the tops of hydraulic jacks 390 and 392, which control the angle between the upper plane of rectangular frame 382 and the horizontal plane. Hydraulic jacks 390 and 392 operate by the help of a pump 394 and a hydraulic circuit 396. Pump 394 is operatively connected to an engine 398 by a mechanical transmission means 400. Hydraulic jacks 390 and 392, pump 394, hydraulic circuit 396, engine 398, and mechanical transmission means 400 are secured to structural frame 356. A control unit 402 including all the control panels and necessary steering tools of mobile object 346 is mounted in the front of pilot cabin 350. Hydraulic mechanical systems (not shown) for lowering and breaking the wheels of the mobile object are powered from engine 398. A fuel tank 404 is mounted in machine cabin 352 so that the center of gravity of mobile object 346 is as closer to the center of the mobile object as possible.

In operation, force generators 370 and 372 are driven from engines 374 and 378 through mechanical transmission means 376 and 380 respectively. Hydraulic jacks 390 and 392 raise or lower the edge of rectangular frame 382 jointed with their tops to give a desirable angle of the axes of force generators 370 and 372 relative to the horizontal plane. Then the total force created by force generators 370 and 372 is resolved into the vertical component and horizontal component. The vertical component is the lift of mobile object 346 and the horizontal component is the propulsion of the mobile object. Thus mobile object 346 can lift, hover in the air, and fly forward or backward by controlling the operation of force generators 370 and 372 and hydraulic jacks 390 and 392. Mobile object 346 yaws by controlling rudder 354. Mobile object 346 rolls by creating a difference between the lifting forces generated by force generators 370 and 372. If a lower part of the skin of body 348 is sealed, mobile object 346 can sail on water surface. Mobile object 346 runs on the ground by wheels 368. Thus mobile object 346 can take-off, hover in the mid-air, fly forward and backward, land, run on the ground, and sail on the water surface.

For increasing flying speed mobile object 346 may be further equipped with an additional propulsion mechanism that may be a horizontally mounted force generator (not shown) or a conventional propulsion mechanism (not shown).

From the foregoing, it will be seen that the present invention provides a new generation of vehicles. The distinguished advantage of the new vehicles is their ability to generate self-action forces, which do not depend on outer environment surrounding them. The advantage is achieved by equipping the vehicles with a plurality of force generators, which are principal components of the invention. The independence from outer environment makes the vehicles universal, much more flexible, and safer, and the infrastructure for their exploitation simpler and cheaper. The advantages of the force generators as propulsion mechanisms are their ability to be enclosed in any vehicle and generate very large forces from any source of energy, since any source of energy can be converted into rotational. The enclosure of the force generators makes the motion of the vehicles much more quiet than that of the conventional ones due to ability of damping noisy down to minimum.

An aircraft equipped with the force generators can take-off and land vertically, hover in space, fly at any altitude being independent of speed of flying, and implement flexible maneuvers. The vertical take-off and landing makes the aviation transport systems much more flexible, simpler, safer, and cheaper.

A flying car equipped with the force generators can take-off and land vertically, hover in the mid-air, fly forward and backward, implement flexible maneuvers, run on the ground, and sail on the water surface. The size of the flying car can be made sufficiently small as an automobile. Therefore, the application of the flying car can solve the jam problem of the traffic system on the ground.

A flying saucer equipped with the force generators is a universal vehicle in the earth's atmosphere and in the cosmos. The flying saucer can accelerate in any direction, implement very complicated maneuvers, come out to the cosmos and return in to the atmosphere smoothly.

A spaceship, which may be the above flying saucer, can continue accelerate in cosmos up to desirable velocity by using the solar or universe energy.

An automobile, a train, and a ship equipped with the force generators can carry heavier loads or move faster.

A submarine equipped with the force generators can dive deeper and maneuver easier in the depth.

A town in cosmos can be constructed as large as desirable by using a large number of force generators.

Flying robots for different purposes can be made by using the force generator's technology.

Accordingly, the main objects and advantages of my invention are to provide vehicles with mechanisms which allow the vehicles to generate their self-action forces for starting, accelerating, lifting, landing, and moving in any direction in the air, cosmos, and water (if it is sealed) and on any ground surface and water surface (if the lower part of its body is sealed). The vehicles will make the mankind's transport system much more flexible, simple, cheap, and faster in both the earth's environment and universe.

The foregoing description illustrates preferred embodiments of the invention. However, it will be apparent to those skilled in the art that the principles and concepts employed in such description may be employed in other embodiments without departing from the scope of the invention. Accordingly, the following claims are intended to protect the invention broadly, as well as in specific forms shown herein.

1-20. (canceled)

21. A force generator comprising:
a generator frame;
a rotor including a shaft, a rotary shell having an open bottom, a means supporting a gas in relative equilibrium inside said rotary shell, said shaft having bearing supporters secured to said generator frame;
a stationary means closing said open bottom of said rotary shell, said stationary means being secured to said generator frame under said open bottom of said rotary shell;
whereby said force generator produces the maximum difference between the pressures of the gas acting on its lower and upper surfaces, i.e. maximum lift.

22. The force generator of claim 21 wherein said means supporting the gas in relative equilibrium inside said rotary shell comprises a plurality of dividing walls extending from said shaft to said rotary shell.

23. The force generator of claim 22 wherein said shaft comprises an assembling member secured to said dividing walls and an assembled shaft.

24. The force generator of claim 23 wherein said assembling member is tubular.

25. The force generator of claim 24 further includes a compensating gas means for compensating the amount of gas exhausted out of the space bounded by said rotary shell and said stationary means due to the centrifugal force during rotation of said rotary shell.

26. The force generator of claim 25 wherein said compensating gas means is a fan in a fan duct.

27. The force generator of claim 25 wherein said compensating gas means is a compressor.

28. The force generator of claim 25 wherein said stationary means is a disk, each of dividing walls is a rectangular plate.

29. The force generator of claim 25 wherein said rotary shell covers the surface swept by the top edges and an upper part of outer edges of said dividing walls due to their rotation about the axis of said shaft, and said stationary means is a circumferential tube having a disk-bottom.

30. The force generator of claim 25 wherein each of said dividing walls is a plate having a trapezium shape.

31. A mobile object including a force generator according to claim 25 and further comprising:
a hermetically sealed generator chamber enclosing said force generator and being filled with a pressurized gas;
a structural frame securing said generator chamber and said generator frame;
an engine being operatively connected to said shaft of said force generator by a mechanical transmission means;
whereby said mobile object produces its self-action force that allows it to accelerate itself in any environment without the use of jets, reactive or external forces, and the self-action force of said mobile object can be increased as many times as desirable due to increasing the pressure of the gas inside said generator chamber.

32. A conventional vehicle including a plurality of force generators according to claim 25 and further comprising:
a hermetically sealed generator chamber enclosing said force generators and being filled with a pressurized air, some of said force generators being vertically mounted and the other force generators being horizontally mounted;
a plurality of engines, the shaft of each of said force generators being operatively connected to one of said engines by a mechanical transmission means to be driven from said engine;
whereby said conventional vehicle produces its self-action force that allows it to accelerate itself in any environment without the use of jets, reactive or external forces, and the self-action force of said conventional vehicle can be increased as many times as desirable due to increasing the pressure of the air inside said generator chamber.

33. A conventional aircraft including a pair of identical counter-rotating force generators according to claim 25 and further comprising:
a hermetically sealed generator chamber enclosing said force generators and being filled with a pressurized air, said force generators being vertically mounted;
a pair of engines, the shaft of each of said force generators being operatively connected to one of said engines by a mechanical means to be driven from said engine;
whereby said conventional aircraft can take-off and land vertically by its self-action force, that also allows the conventional aircraft to fly at any height and lift larger weight by increasing the pressure of the air inside said generator chamber.

34. The conventional aircraft of claim 33 further including another pair of identical counter-rotating force generators according to claim 25 and another pair of engines, said force generators being horizontally mounted inside said hermetically sealed generator chamber for propulsion, the shaft of each of said force generators being operatively connected to one of said engines by a mechanical transmission means to be driven from said engine;
whereby said conventional aircraft produces its self-action force for propulsion that can be increased as many times as desirable due to increasing the pressure of the air inside said generator chamber.

35. The conventional aircraft of claim 34 wherein the wings of said conventional aircraft is removed.

36. A mobile object including a plurality of pairs of identical counter-rotating force generators according to claim 25 and further comprising:
a structural frame;
a flying saucer shaped body being secured to said structural frame;
a passenger cabin having a floor attached to said structural frame, a plurality of doors for human gateways, and a plurality of screen windows for human vision;
a turning means;
a control motor;
a hermetically sealed generator chamber being filled with a pressurized air, said force generators, said turning means, and said control motor are mounted inside said generator chamber, the force generators of one of said pairs being horizontally mounted on said turning means, which is controlled by said control motor, the force generators of the other pairs being vertically mounted for lifting;
a plurality of engines;
an auxiliary power unit;
a pump system being powered from said auxiliary power unit for pressurization of the air in said generator chamber and said passenger cabin;
a machine cabin for mounting said engines, said auxiliary power unit, and said pump system, the shaft of each of said vertically mounted force generators being operatively connected to one of said engines by a mechanical transmission means to be driven from said engine, the shafts of said horizontally mounted force generators being operatively connected to one of said engines by a mechanical means to be driven from said engine, each of said engines being connected to said mechanical means by a means selectively disengaging said engine from said mechanical transmission means;
a plurality of suspension piers allowing said mobile object to stand on the ground;
a plurality of wheels allowing said mobile object to run on the ground;
a fuel tank being mounted in said machine cabin for providing said engines and said auxiliary power unit with fuel;
a control system being mounted in a cockpit for controlling the devices of said mobile object;
whereby said mobile object produces its self-action force that allows it to accelerate itself in any direction and environment without the use of jets, reactive or external forces, and the self-action force of said mobile object can be increased as many times as desirable due to increasing the pressure of the air inside said generator chamber.

37. The mobile object of claim 36 further including photovoltaic panels and a plurality of electrical motors powered from said photovoltaic panels, each of said electrical motors being connected to one of said mechanical transmission means by a means for selectively disengaging said electrical motor from said mechanical transmission means; whereby said mobile object can accelerate itself by using solar energy.

38. A mobile object including two identical counter-rotating force generators according to claim 25 and further comprising:
a structural frame;
a body of aerodynamic shape being secured to said structural frame;
a pilot cabin having a floor attached to said structural frame, a door for human climbing, and a glass screen for human vision;
a pair of engines;
a tilting means having an upper plane;
a machine cabin for mounting said force generators and said engines, said force generators being vertically mounted for lifting on the upper plane of said tilting means, the shaft of each of said force generators being operatively connected to one of said engines by a mechanical transmission means;
a plurality of suspension piers allowing said mobile object to stand on the ground;
a plurality of wheels allowing said mobile object to run on the ground;
a fuel tank mounted in said machine cabin for providing said engines with fuel;
a control unit mounted in the front of said pilot cabin for controlling the devices of said mobile object;
whereby said mobile object produces its self-action force for vertical taking-off and landing and horizontal propulsion without the use of jets, reactive or external forces.

39. The mobile object of claim 38 wherein said tilting means comprising:
a hydraulic circuit having a pump that is powered from another engine mounted in said machine cabin;
a pair of hydraulic jacks that are operatively connected to said hydraulic circuit;
a pair of struts being secured to said structural frame;
a rectangular frame for securing said force generators, the ends of one edge of said rectangular frame being operatively jointed with the tops of said hydraulic jacks, said rectangular frame having a shaft and bearing supporters arranged in said struts.

40. A mobile object comprising:
a structural frame;
a hermetically sealed generator chamber being filled with a pressurized gas and secured to said structural frame;
a rotor of blades having an airfoil cross-section and being enclosed inside said generator chamber;
a shaft for mounting said rotor of blades, said shaft having bearing supporters secured to said structural frame;
a pump system for pressurization of the gas in said generator chamber;
an engine being operatively connected to said shaft by a mechanical transmission means;
whereby said mobile object produces its self-action force defined by the lift of said rotor of blades that allows it to accelerate itself in any environment without the use of jets, reactive or external forces, and the lift of said rotor of blades can be increased as many times as desirable due to increasing the pressure of the gas inside said generator chamber.
